(19) United States
(12) Patent Application Publication
(10) Pub. No.: US 2024/0273445 A1
(43) Pub. Date: Aug. 15, 2024

(54) Hierarchical Ranking of Entities Including Individuals and Institutions

(71) Applicant: Meta Analytics, LLC, Los Angeles, CA (US)

(72) Inventor: Amir Faghri, Los Angeles, CA (US)

(21) Appl. No.: 18/231,515

(22) Filed: Aug. 8, 2023

Related U.S. Application Data
(60) Provisional application No. 63/445,350, filed on Feb. 14, 2023.

(51) Int. Cl. G06Q 10/0639; G06Q 50/20

(52) U.S. Cl. CPC G06Q 10/06393; G06Q 50/205

(57) ABSTRACT

In one embodiment, a method includes receiving a request from a user for a ranking of a plurality of entities, the ranking based on a plurality of ranking metrics for each entity, each entity associated with a profile in a profile database. An entity's associated profile contains information corresponding to each of the plurality of ranking metrics for that entity. The method further includes providing, in response to the request, a user interface comprising a ranking of the plurality of entities.

### PRIORITY CLAIM

This application claims the benefit under 35 U.S.C. § 119 of U.S. Provisional Patent Application 63/445,350 filed Feb. 14, 2023.

### TECHNICAL FIELD

This application generally relates to systems and methods for hierarchical ranking of entities including individuals and institutions.

### BACKGROUND

In many disciplines, entities are ranked according to a variety of criteria, and such rankings are used to determine relative standings of those entities according to the criteria. For example, academic institutions (e.g., colleges, universities, etc.) and those institutions' subdivisions (which are referred to herein as Units, such as Schools and Colleges or Departments), may be ranked by a variety of ranking bodies. These rankings may be used by academic administrators to gauge the academic standing and/or productivity of Units within the Institution either relative to other Units within the Institution or to Units external to the Institution. Other rankings may be used by the general public to assist in decisions they make relative to choices of institutions to support, attend, or associate with. As another example, individuals within academia, such as researchers, professors, instructors, etc., may be ranked relative to a variety of criteria. Other examples of rankings include entities in competition (e.g., sports teams, business competitors), content (e.g., movies, books, etc.), artists, movie producers, and so on.

### BRIEF DESCRIPTION OF THE DRAWINGS

FIG. 1 illustrates examples of Fields, Disciplines, and Specialties and the relationships between them.

FIG. 2 illustrates an example profile for an individual.

FIG. 3 illustrates an example process for generating profiles and rankings for various entities, such as individuals and institutions.

FIG. 4 illustrates example rankings for an individual.

FIG. 5 illustrates an example list of individual rankings.

FIG. 6 illustrates an example user interface (UI) for a Field.

FIG. 7 illustrates an example UI for a Discipline.

FIG. 8 illustrates an example UI for a Specialty.

FIG. 9 illustrates an example UI for an institution.

FIG. 10 illustrates example profile database entries.

FIG. 11 illustrates an example architecture for the systems and methods disclosed herein.

FIG. 12 illustrates an example disambiguation process.

FIG. 13 illustrates an example of the data flow and certain procedural components involved in the scholar and institutional ranking process.

FIG. 14 illustrates an example of the distribution of relationships between primary data entities in the system.

FIG. 15 illustrates an example computer system.

### DESCRIPTION OF EXAMPLE EMBODIMENTS

Existing ranking methodologies are known to exhibit a number of significant flaws. Examples of such flaws are provided below in the context of academic rankings, although some or all of these flaws are often present when ranking other entities.

A primary flaw in certain rankings is the use of subjective assessment of Units by reviewers. These subjective assessments may constitute a large component of a Unit's overall rank. The rigidity of ranking methodology is another flaw exhibited by almost all extant ranking schemes; only such metrics as the ranking scheme is able to or willing to provide are made available. Additionally, the entities and publications that provide rankings generated by implementing the ranking schemes typically only provide a gross overview of the relative performance of Units, and lack specificity, temporal history, and, depending on how the rankings have been determined, accuracy.

Another major problem with existing ranking methodologies is that ranking databases are not universal. For example, in the context of ranking individual researchers and scholars, there is no single database which captures all active, retired and even deceased scholars or researchers (both academic and industrial). Existing ranking approaches are of limited value because of the lack of universality and because of issues related to the identification of both the scholars/researchers themselves and the peer group to which they belong. Problems for all individualized rankings include the necessity to disambiguate between two or more scholars/researchers sharing the same name and the necessity to uniquely identify scholars/researchers who use various spellings of their name (e.g., including or excluding full first names, middle names, accented characters, name changes due to change in marital status, etc.)

Moreover, current ranking schemes applied to either individuals or Units do not adequately describe variations and trends in ranking over time. Users of certain rankings may attempt, by examination of historical rankings, to determine trends for themselves, but the ability to compare an individual's trend to that of their peer group is not currently supported within a single existing ranking scheme. While such individualized rankings based on metrics such as the h-index may demonstrate an individual's lifetime standing at the current point in time, metrics such as the h-index do not capture variation over the individual's lifetime. Standardized time-dependent rankings of scholars/researchers at various stages of their careers are not available to administrators (or the scholars themselves) to inform the administrators or the scholar of the scholar's progress relative to their peers.

In addition, conventional ranking schemes are either purely Unit-based or individual-based, i.e., they may compare (say) Departments of Mechanical Engineering or individual Mechanical Engineers; however, there is no flexibility in the definition of a Unit or of an individualized peer group. With current ranking schemes it is not possible to rank all scholars/researchers relative to a unique Specialty, or combination of unique Specialties, (such as “scholars/researchers who specialize in the application of Heat Pipes to the issue of CPU Cooling”).

Conventional ranking schemes typically use inflexible definitions for partitioning individuals or Units into comparative groups e.g., rankings of Units partitioned by department name, or individuals by the department to which they are affiliated. Such inflexible divisions ignore the reality of the academic enterprise, in which an individual who is active in a particular Field or Discipline may be in an institutional subdivision (e.g., College/Department) not named for the area. For example, some computer scientists may work in a department of mathematics, or a department of electrical engineering and some may even be associated with such disparate departments as psychology, linguistics, fine arts or philosophy in contrast to their being associated with the expected department of computer science. The ranking of such individuals may be arbitrarily penalized (or may be arbitrarily rewarded) relative to the rankings of their peers when metrics such as the h-index are used if the typical values of the metrics in the individual's area of expertise are different than the typical values of the metrics in the department to which they are affiliated.

The static definitions of research foci (e.g. including all Mechanical Engineers in one group) used by conventional ranking systems do not correspond to the realities of research activities where Specialties evolve and decline over time, where Specialties are routinely associated with multiple Disciplines and Fields, and/or where individual researchers change their departmental, school and college affiliations over their careers (e.g. a researcher in Physics joining a Mechanical Engineering department). It is insufficient to associate individuals or groups with static labels drawn from a set of descriptors. Likewise, it is not reliable to permit individuals to self-identify their particular areas of expertise; many individuals may self-identify with an area they in fact do not work in, or they may self-identify an area they no longer work in. Moreover, areas of research activity often change rapidly as new issues arise or new discoveries are made. Therefore, it is advantageous for any meaningful ranking scheme to be able to capture and to define automatically the Specialty or Specialties that individuals work in based purely on the factual evidence provided by their scholarly work in the form of publications, grants, patents or award data. Moreover, the association of an individual with a Specialty or set of Specialties should be able to adapt dynamically to capture both an individual's current set of interests and any prior sets of interest.

In conventional ranking metrics, a common method used by extant ranking schemes is to standardize the data by using the z-score (standard score). Care must be taken in the use of z-scores if the underlying distribution is not normal; thus, conversion from z-scores to percentiles must take into consideration the realities of the distribution of the underpinning factual data (e.g. numbers of publications of each research in a particular Specialty). While strategies such as normal score transformation can be used to mitigate the effect of non-normally distributed data on the use of z-scores, extant ranking schemes do not necessarily deploy these strategies.

Finally, conventional ranking schemes are factor-free, in the sense that the end users are presented with a single ranked variable often described as an “overall score” created from a weighted sum of multiple factors (with weights chosen by the ranking entity) rather than a presentation of the breakdown of the various factors (ranking variables) and any statistical relationships these factors might exhibit.

The most well-known ranking exercise is that of US News and World Report. Their ranking of institutions is not explicitly an academic ranking, since it includes socio-economic factors such as mobility of students, retention rates of students and financial resource availability. Subjective metrics (“expert opinion”) forms as much as 20% of the total ranking, while the quality of the research performed in the institution is not even considered. For example, their rankings for Fields e.g., those computed for Engineering, include a 25% contribution from subjective assessment (opinions of academics at other institutions). Such subjective assessments have long been condemned as lacking in rigor, unreliable, and propagating the “halo effect”, whereby a highly-ranked school or program receives high subjective assessments and rankings whether or not the objective data supports the assessment and ranking.

The World University Rankings (Times Higher Education, UK) is another ranking exercise heavily invested in subjective analyses; of the five major ranking subdivisions they consider (Teaching, Research, Citations, International Outlook and Industry Income), a full 33% of the ranking (15% in teaching and 18% in research) is derived from subjective opinions. To demonstrate the effect of this subjectivity, as of 2019 the World University Rankings place Oxford and Cambridge Universities (in the UK) as the top two overall institutions. In contrast, the Academic Ranking of World Universities (ShanghaiRanking) ranking scheme is objective. According to ShanghaiRanking, the top universities are Harvard and Stanford (USA), with Cambridge ranked 3rd and Oxford ranked 7th. It is therefore clear that subjective influences placed Oxford higher in the World University Rankings than the rankings generated by ShanghaiRanking's objective score. However, the ShanghaiRanking scheme is not without shortcomings since it includes such factors as the number of alumni who have won Nobel Prizes (where appropriate, i.e., if applicable) or Fields Medals (where appropriate), or the number of faculty or staff of an institution who have won such prizes, and these rankings do not distinguish whether (for example) a faculty member obtained such a prize while working at the institution, or whether they were hired by the institution after obtaining the prize. While such prizes may contribute to the overall ranking of an institution, the weighting of the contribution should reflect whether the institution itself supported such prize-winning research, or whether some other institution supported the prize-winning research.

Both the US News and World Report and Times Higher Education World Ranking use size-dependent indicators and therefore their rankings are influenced by the number of faculty members in the academic institutions or programs. Furthermore, universities or programs with emphases on Fields such as social sciences and humanities (which tend to have fewer publications and thus fewer citations) are not fairly evaluated against universities or programs with a strong representation in Fields such as Engineering and Medicine.

Other ranking exercises exist and exhibit various shortcomings. Google Scholar allows scholars to create their profiles and share them in public, but not all scholars opt to create a Google Scholar profile, and although Google Scholar ranks scholars in terms of their h-index and citation counts regardless of their Field, there are no metrics used that are specific to a scholar's Field, Discipline, or Specialties. Both Scopus and Web of Science provide limited profiles, and they assign scholars into a coarse classification of Fields or Disciplines but do not assign scholars to Specialties. In the case of Scopus, scholars are classified into 22 broad Fields and 176 sub-Fields but the association of scholars to Fields and Disciplines is opaque, and each scholar may be assigned to several Fields and/or several Disciplines. Both Web of Science and Scopus routinely publish the rankings of top scholars, usually based on citation counts or h-indices. In Clarivate's (Web of Science) case, the ranking of top scholars is based on citation counts and is limited to scientists and social scientists, excluding a massive number of scholars in academia. Elsevier, in collaboration with other groups, has published the “top 2%” of scientists with data drawn from Elsevier's Scopus database, and their rankings for top scholars are based on both citation counts and h-index. Neither Web of Science nor Scopus rank institutions and programs.

The system ranking scheme described in US Patent Application Publication No. US 2006/0265237 produces a ranking of academic programs by gathering basic information such as numbers of honors and awards, books and publications, citations, funding and number of faculty in a program. This publication states that division of the basic metrics by faculty size followed by partial correlation analysis and standardization using z-scores enables side-by-side comparison of programs. However, the ranking scheme does not provide any ranking by Specialty, nor does it provide any individualized ranking of researchers, nor does it provide time-series analyses of Programs, Fields, Disciplines, or Specialties, and is thus deficient relative to the current invention.

The most common individualized metrics in use for ranking academics/researchers include the number of total papers published, the total number of papers published in authoritative (prestigious) publication venues, the number of citations of such papers, the number and value of grants and contracts awarded, and the number of prizes or other honors awarded. Owing to widely varying interpretations of the validity of such metrics, especially the number of publications and citations, attempts have been made to regularize the metrics, such as the h-index. Use of the h-index has led to some criticism, and alternative metrics also exist. Embodiments of this disclose are agnostic to the particular metric used, in that end-users need not use only a single metric and instead can elect to choose any one of the various ranking metrics provided by these embodiments.

In contrast to the conventional approaches described above, this disclose describes computer-based systems and methodologies for a) the development of a hierarchy over any set of endeavors (such as but not limited to: academic, governmental and industrial research, sports activities, professional activities, artistic activities, corporate performance, financial activities, activities related to nation states or subdivisions thereof etc.); b) the accurate profiling of participants (individuals and/or institutions) within the totality of the corpus of individuals or institutions participating in the endeavor hierarchy; and c) a suite of ranking methodologies applied to individuals or institutions over the hierarchy constructed relative to the specified endeavor. As described more fully below, the systems and processes described herein include a variety of computer-based subsystems and computational subprocesses (including but not limited to the use of novel data mining, artificial intelligence, machine learning, statistical analyses and database systems and processes for the purposes of specification of the hierarchy, profile generation of the participants and rankings created relative to the hierarchy, as described more fully herein.).

For example, as explained below, embodiments of the systems and associated ranking methodologies disclosed herein use computational processes capable of providing a complete set of rankings of all individuals (active, retired or deceased) who have a publication history. As another example, embodiments of the systems and associated ranking methodologies disclosed herein use computational processes capable of providing rankings relative to a partitioning of the research community by Field, Discipline and Specialty or Specialties. As another example, embodiments of the systems and associated ranking methodologies disclosed herein provide a fully objective hierarchy of ranked institutions, not only by institutional divisions (University, School or College, Department) but also by Fields, Disciplines and Specialties. As another example, embodiments of the systems and associated ranking methodologies disclosed herein provide a fully automated way to uniquely identify individual researchers, for example by disambiguating among common names. As another example, embodiments of the systems and associated ranking methodologies disclosed herein automatically determine and assign researchers to Fields, Disciplines, and Specialties based on their published activities rather than subjective assessments.

As explained in examples herein, embodiments of this disclosure generate standardized, comparative rankings of individual scholars, institutions (or subdivisions of institutions) relative both to an innovative and dynamic partitioning of the domain of activities of all scholars into distinct Fields, distinct Disciplines, and distinct Specialties (which may themselves be further refined, e.g., into Subspecialities and sub-Subspecialties) as well as rankings relative to institutional categories such as Schools, Colleges, Departments and Centers. However, as explained above, the systems and methods described herein are not restricted to academic and industrial research, and instead apply to the provision of standardized comparative rankings using various ranking schemes for any activity for which individual merit scores or performance data or similar quantitative information is available (e.g., sports activities, professional activities, artistic activities, corporate performance, financial activities, activities related to nation states or subdivisions thereof, etc.).

This disclosure is directed to systems and methods for ranking entities, such as individual researchers and institutions (or subdivisions thereof), relative to a number of i) certain specific statically-defined ranking partitions including but not limited to such partitions as by institution, by school (or college), by department, by center, by Field, and by Discipline; ii) dynamically generated ranking partitions including but not limited to by geographic area, by specialty or specialties of scholarly activity, and by specific time-period; iii) any Boolean combination of items from i) and ii) including but not limited to such partitions as “top ranked departments of Mechanical Engineering in the Pacific Northwest relative to the Specialty of Energy” or “top ranked individuals in Energy in Los Angeles independent of industrial or academic affiliation” and iv) any set time period for which records exist relative to any Boolean combination of ranking metrics as given in iii). The computational system and data storage system described herein may or may not be cloud-based and is able to dynamically adjust to varying computational loads with a variety of user interfaces for a variety of different user categories which encapsulates a variety of computational methods acting over a variety of database structures to capture automatically and provide a dynamically updated database of uniquely identified individual research profiles which contain items including but not limited to the individual's name; list of affiliations (past and present); list of published journal papers, books, conference proceedings and monographs; citations associated with each publication, patents, grants and contracts including sources, amount and duration, prizes and honors; to which are automatically appended the individual's expertise by Specialties as appropriate. To create this database, the computer-based system and associated computational processes automatically and periodically scans a wide variety of data sources from which it accesses raw data; it deploys tools from Artificial Intelligence and Data Mining to disambiguate individuals and entities that share a name and to accurately identify individuals and entities, including based on common idiosyncrasies including but not limited to the use of full spellings or use of initials of first names, order of last names and first names, or use of or lack of accented characters in names or affiliations. Particular embodiments are able to distinguish between authors sharing a common name, for example by using Artificial Intelligence to associate names with specific areas of Specialty. The ranking approaches use information generated by the systems and methods described herein to rank individuals and institutions using appropriate ranking metrics.

Embodiments of the current disclosure include one or more digital computer-based systems each including one or more computers each of which includes one or more central processing units which may or may not be virtual, each of which may contain one or more processors, each of which may have one or more processor cores, together with one or more attached memory hierarchies comprising one or more fast cache memories and one or more large-scale random access memories, attached directly or indirectly to which computer systems are one or more large-scale secondary storage devices, including but not limited to fast solid-state secondary storage devices, magnetic disk devices and magnetic tape devices, the ensemble being connected with each other and to the external world using one or more high-speed data paths including but not limited to one or more high-speed data buses and networking technologies to which may be attached one or more input and output devices as well as any other computer-based systems capable of interfacing to the larger ensemble, whether through one or more networking technologies or any other interconnection fabric deemed appropriate, the entire computer-based system being managed and defined as a computer and storage capability so constructed and managed as to be able to dynamically adapt in terms of processing capability, storage size and network bandwidth according to user demands placed upon it.

Stored within the computer-based system on one or more secondary storage devices and available to and readable by and executable by all computational facilities which make up the fabric are sequences of instructions and any and all associated data and any and all associated metadata which individually and severally constitute one or more computer programs which effect all method steps pertaining to the disclosure including but not limited to i) the periodic acquisition of all required data pertaining to the intent of the disclosure to rank or sort individuals and institutions (or subdivisions thereof) consisting of strings of text and numbers represented in one or more established digital formats, or any future digital format; ii) the pre-processing of that data into a set of standardized data formats according to rules and syntactical definitions contained within said computer programs and their associated data and metadata; iii) the disambiguation of all entries in that data into uniquely identifiable entities, whether such entities be names of people, places or concepts, or any other entity of interest requiring said disambiguation; iv) the generation of a set of unique individual profiles of all individuals affiliated with institutions of higher education or other entities involved in scholarly pursuit, or who have published materials conventionally deemed to constitute a contribution to the advancement of knowledge, or who have received a grant or contract related to an advancement of knowledge, or who have been awarded a patent, or who have been awarded a prize or other honor as a result of some contribution or contributions they have made to the advancement of knowledge, or who have some combination of the above factors; such individual profiles to contain such entries as:—the individual's name, rank or position, degrees awarded, institutional address or addresses in full, including every subdivision of the institution or institutions with which the individual has an affiliation; all prior institutional affiliations held by the individual; all publications made by the individual, whether individually or jointly with others, such publication data to include all pertinent information associated with the publication including but not limited to title, author or authors, author or author affiliations, keywords, publication venue, type of publication, pagination of publication, date of publication and all citations making reference to that publication, whether self-cited by the author or a co-author or cited independently by other authors; the names, dates, amounts and sponsor details of all grants and contracts held by the individual; and the names, dates and awarding entity of all honors and prizes associated with the advancement of knowledge awarded to the individual, whether individually or jointly; iv) the construction of a multi-way searchable database comprising records of each individual profile, to be stored on the computer-based system described above; v) the computation of numerical values of a variety of fundamental ranking metrics as described in this disclosure including but not limited to such measures as overall number of publications; citations per publication; number of publications per year and per Specialty associated with the individual; citations per year and per Specialty; h-index and other associated indices determined overall, per year, per Specialty, and per Specialty per year; funding levels both overall and per year; degree of collaboration both intra-nationally and internationally overall and per year, all of which to be updated periodically and automatically; vi) the computation of the numerical values of a variety of derived ranking metrics derived from the methods described in this disclosure, including but not limited to such derived metrics as Productivity, Impact and Quality, computed both overall or per year, or even over a period of multiple years, or any other time period, all of which to be updated periodically and automatically; vii) the partitioning of the individual profile database into a variety of static partitions relative to institutions, subdivisions of institutions, Fields and Disciplines, and partitioning of the individual scholar database into a number of dynamic partitions relative to Specialties and the subsequent generation of fundamental ranking metrics derived with regard to these partitions, including but not limited to such measures and their means, medians, skewness, kurtosis and other relevant statistical information as overall number of publications; citations per publication (either total or excluding self-citations); number of publications per year and per Specialty associated with the individual (total, or weighted by factors such as but not limited to the number of co-authors); citations (total, or weighted by factors such as but not limited to the number of co-authors and including or excluding self-citations) per year and per Specialty; h-index (total, or weighted by factors such as but not limited to the number of co-authors and including or excluding self-citations) and other associated indices determined over all years, per year, per Specialty, and per Specialty per year; funding levels both over all years and per year; degree of collaboration both intra-nationally and internationally over all years and per year, all of which to be updated periodically and automatically; viii) the computation of the numerical values of a variety of ranking metrics used in the ranking scheme described in this disclosure computed over all such static and dynamic partitions, including but not limited to such derived metrics as Productivity, Impact and Quality, computed both over all years and per year, all of which to be updated periodically and automatically; ix) the provision of a variety of interface methods to enable users to interact with and query the computer-based system; x) an administrative component permitting or restricting access to the computer-based system dependent on one or more pre-defined classes of user; xi) a computational means permitting authorized users to augment certain components of the individual profile database by adding notifications intended to correct any residual errors in the individual profiles or add information missing from the individual profiles, but constructed in such a way as to maintain the integrity of the individual profile database.

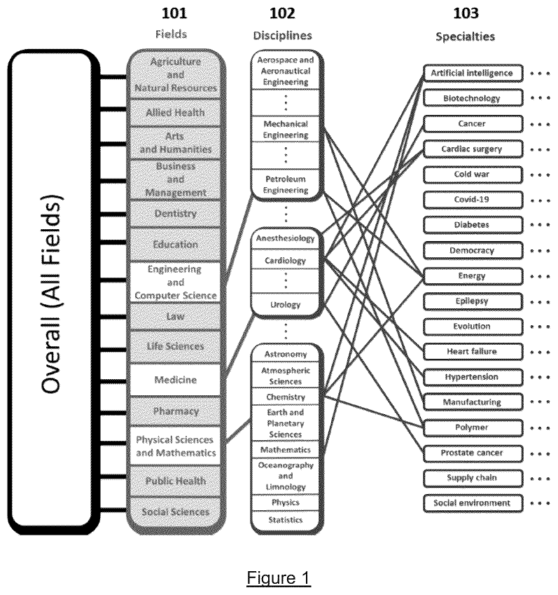

The unique definitions of Fields, Disciplines, and Specialties used to demonstrate an example of the systems and processes described herein in the context of academic and industrial research are presented diagrammatically in FIG. 1. In this diagram each Discipline is associated with one and only one Field, but each Specialty can be associated with multiple Disciplines. It is understood that in the context of this disclosure, Specialties may be sub-divided into Subspecialties, and Subspecialties might be sub-divided into sub-Subspecialties, and so on as appropriate. Subspecialties, sub-Subspecialties and so on can also be considered in the context of ranking individuals and institutions including but not limited to those engaged in governmental and industrial research, sports activities, professional activities, artistic activities, corporate performance, financial activities, activities related to nation states or subdivisions thereof. In particular embodiments, multiple subspecialities may be associated with one specialty, and a subspecialty may be associated with more than one specialty.

As illustrated in the example of FIG. 1, Fields 101 correspond to typical colleges and schools commonly found in academic institutions. Example Disciplines 102 correspond to departments at most academic institutions, and example Specialties 103 are associated with unique research foci.

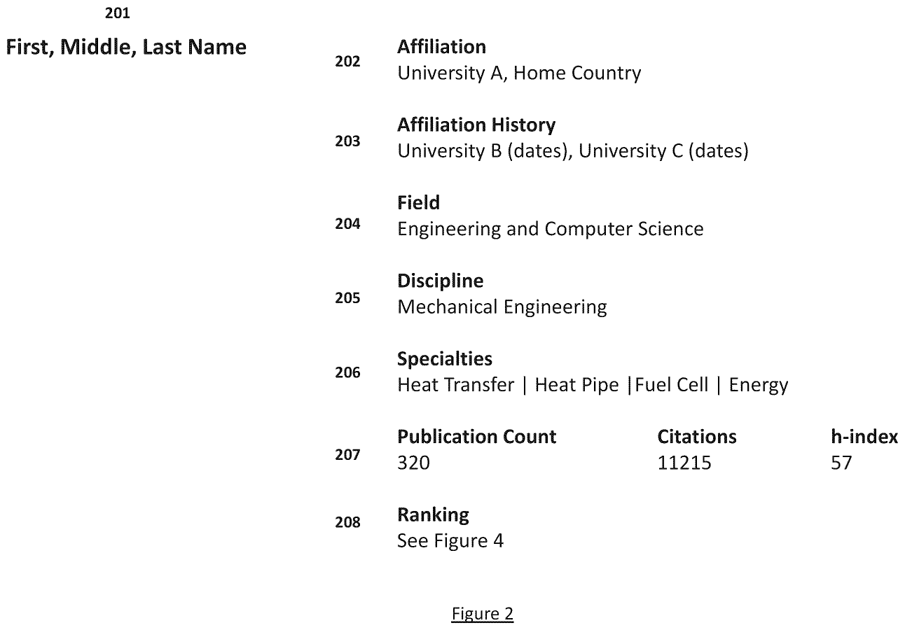

Digital data records from a variety of sources are periodically (e.g., every day, every week, every month, etc.) accessed to generate profiles of individuals. FIG. 2 illustrates an example profile for an academic researcher. The example profiled in FIG. 2 includes, but is not limited to: the name of the individual 201, the individual's affiliation 202, the individual's affiliation history 203, the individual's Field 204, the individual's Discipline 205, the individual's Specialties 206, the individual's publication, citation, and h-index metrics 207, and a link to the individual's ranking 208.

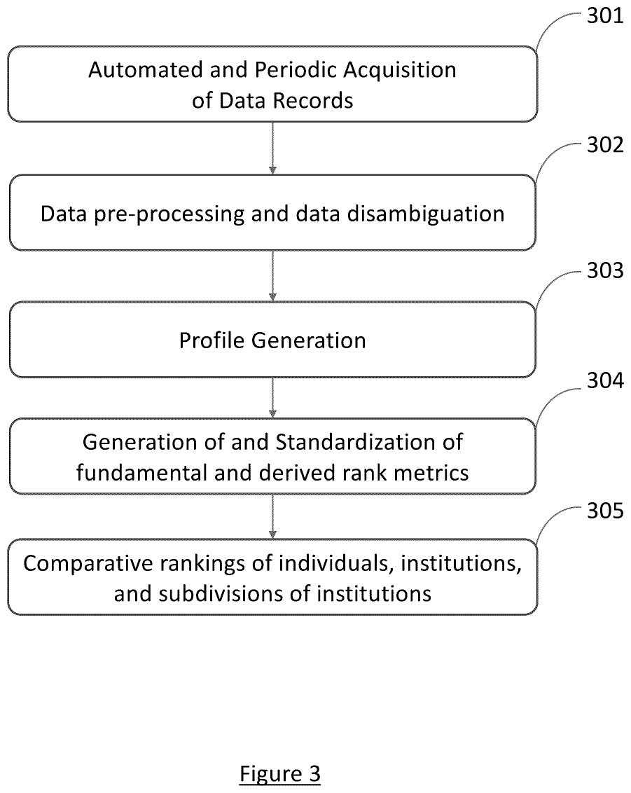

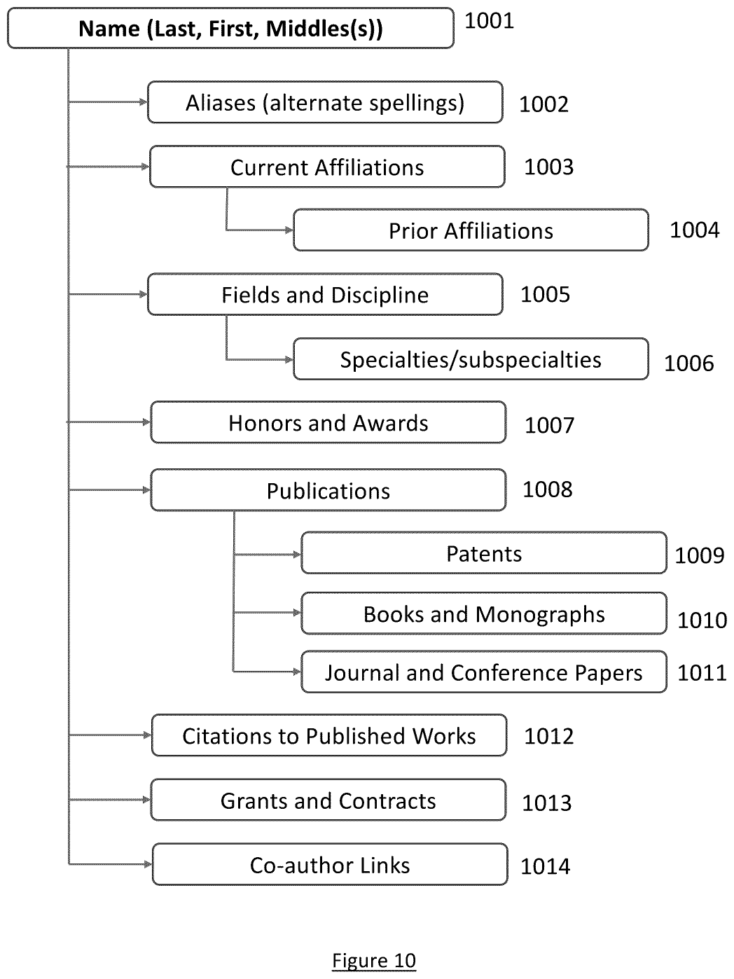

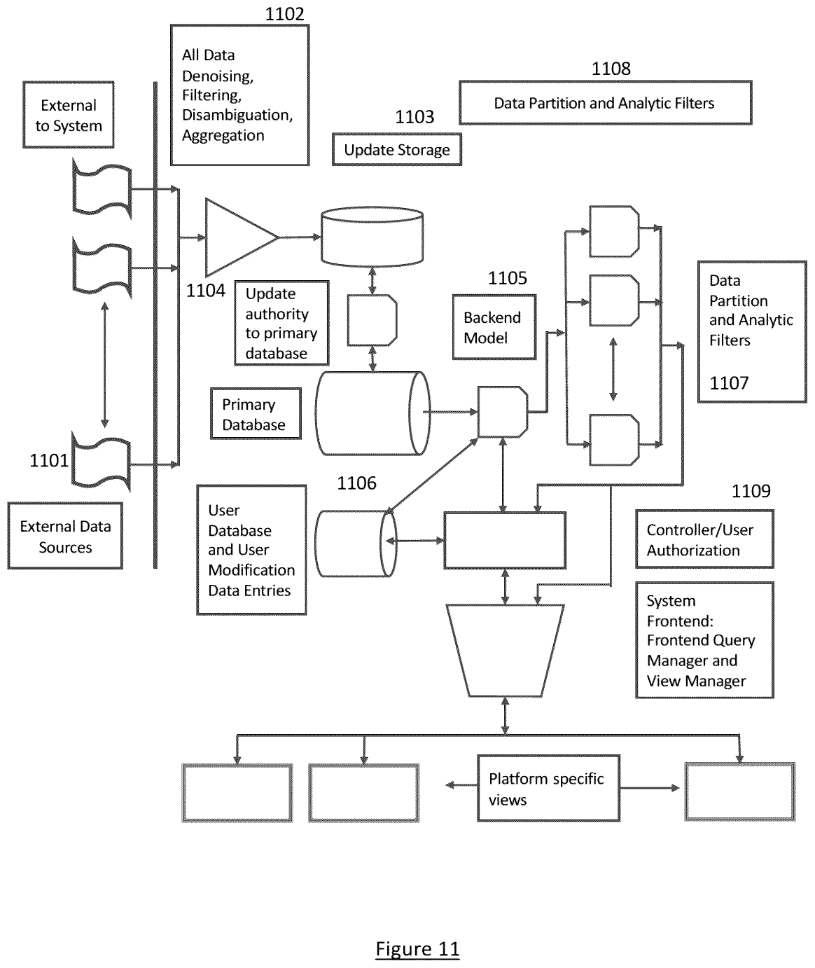

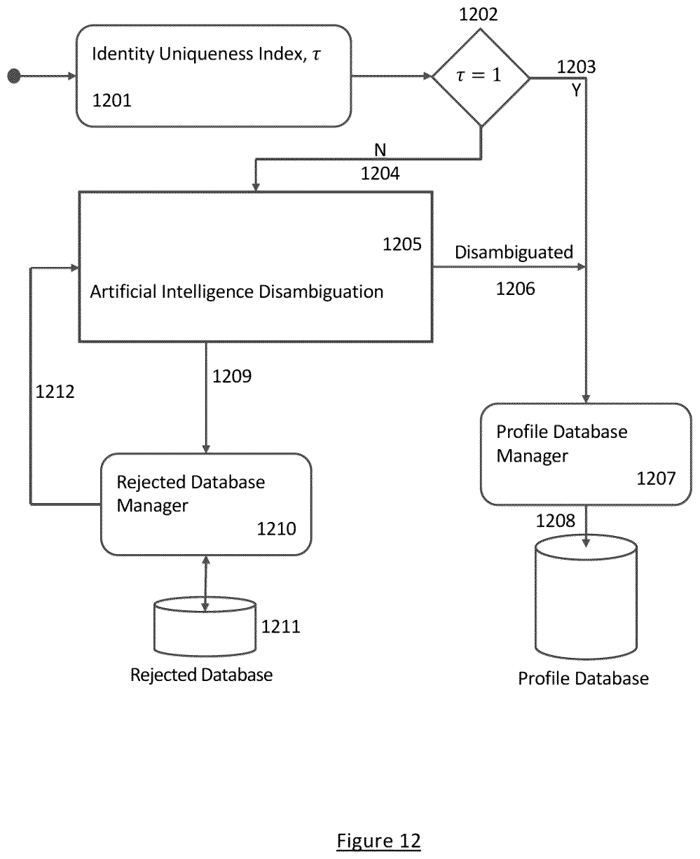

FIG. 3 illustrates an example process for generating profiles and rankings for various entities, such as individuals and institutions. As shown in the example of FIG. 3, the process includes accessing data from a variety of distinct sources 301. In particular embodiments, this raw data is aggregated and stored in a long-term raw data record storage system (see FIG. 11). In the example of FIG. 3, the data records are subsequently pre-processed 302 in order to convert the raw data records acquired in the step described previously into a specific format as described in this disclosure (e.g., FIG. 10). During step 302, simple equivalent correspondences (such as “Dept.” and “Department”), basic foreign equivalences (such as école≡school) and equivalent technical and Discipline-related terminology (such as “religion” and “divinity”) are converted to a uniform set of terms for further processing, as described below. In the example of FIG. 3, author name disambiguation also takes place in step 302 (see FIG. 12). Such author disambiguation assigns each author name to a unique individual, even when multiple unique individuals share precisely the same name or when a unique individual publishes under multiple names (e.g., using a shortened name (“Jeff” instead of “Jeffery”) or with or without a middle name, etc.).

Once the raw data records have been converted to the standardized set of terms, labels, tags and other descriptive entities and the author names have been disambiguated, profiles in a profile database are created or updated in step 303. For example, if a profile exists for the individual uniquely identified in step 302 then the profile may be updated with new data accessed in step 301 and pre-processed in step 302, and if a profile in the profile database for such individual does not exist, then a new profile for that individual is created.

In the example process of FIG. 3, step 304 includes periodically evaluating a number of different fundamental and derived metrics taken from a number of different partitions of the profile database into equivalence classes, including but not limited to such equivalence classes as the equivalence class including all Universities, that including all Colleges and Schools of Engineering, that including all Departments of Mechanical Engineering, and that including individuals active in the Specialty identified as Heat Transfer. The metrics may be evaluated periodically, such for a profile after that profile is updated or created, and/or may be evaluated on demand, such as when a user requests evaluation. Such metrics include but are not limited to such fundamental metrics as total number of, mean number of, and median number of papers published, h-index and total amount of, mean amount of and median amount of grants and contracts awarded; and such derived metrics as total Productivity, Impact and Quality. In the example process of FIG. 3, such metrics are then standardized 305 using conventional statistical methodologies including those drawn from parametric and non-parametric statistics to enable within-metric and cross-metric comparisons and rankings to be made.

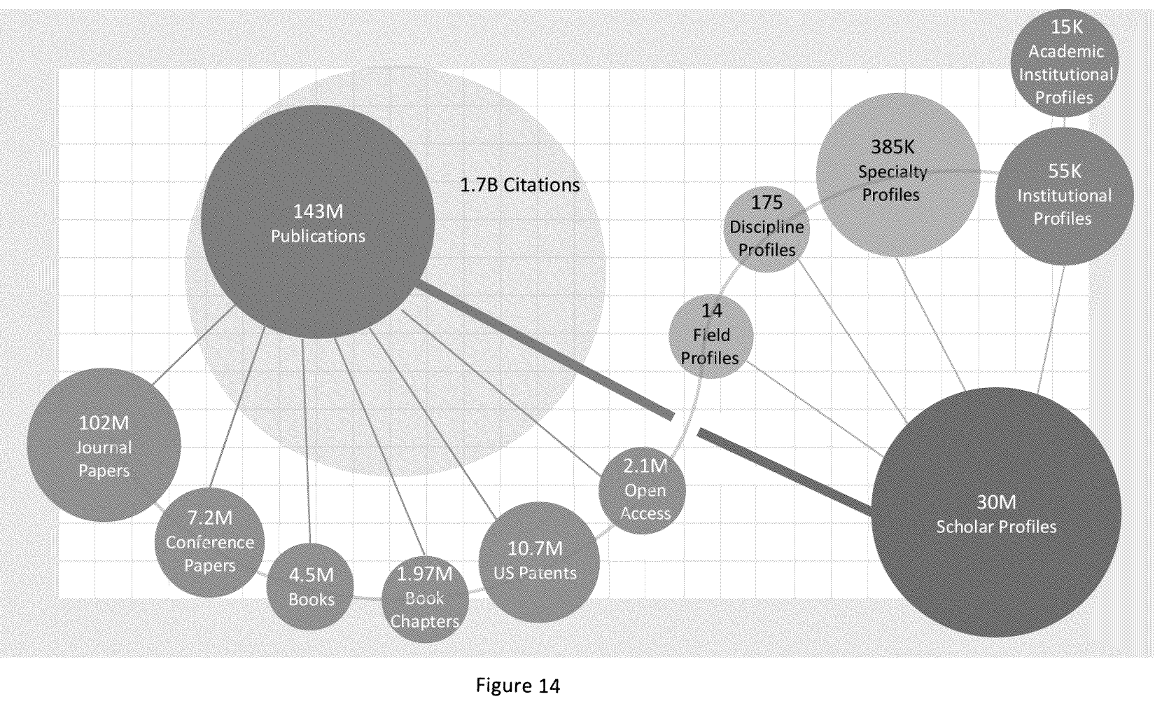

In particular embodiments, the number of, and labels for, fields and disciplines may be predetermined, or fixed, in a database. In contrast, the number of, and labels for, specialties and subspecialities may be dynamic, in that specialties can be added or removed as external data is accessed and processed. In addition, the relationships between specialties and disciplines may also be dynamic. For example, a specialty of “quantum dots” may be created based on external information and associated with a “computer engineering” discipline. Then, an association between the “quantum dots” specialty and a “chemistry” discipline may be added based on external information associating the use of quantum dots as catalysts in a chemical reaction. As a result, specialty data may be particularly fine grained, as there may be orders of magnitude more specialties than there are fields or disciplines (e.g., as illustrated in the example of FIG. 14).

In particular embodiments, an individual's discipline and field may be determined based on a combination of data including the individual's specific publications (e.g., title, abstract, and type of journal), work history, and educational background. These inputs may be, for example, input to a trained machine-learning model or to a rule-based model to classify the individual into a unique field and discipline.

Particular embodiments of the systems and methods disclosed herein predict the affiliation history of scholars. For example, affiliations may be predicted by identifying the affiliations associated with each publication listed on a scholar's profile page. Some publications may have multiple affiliations due to multiple authors from various institutions.

Particular embodiments of the systems and methods disclosed herein provide accurate predictions for Fields, Disciplines, and Specialties. As discussed herein, Fields represent the highest structural levels of expertise, such as Engineering and Computer Science, Medicine, or Arts and Humanities. Disciplines are divisions within Fields, such as Electrical Engineering, Orthopedics, and History, which align with standard divisions and subdivisions within the academic community. In particular embodiments, each Discipline is unique to only one Field. Specialties, on the other hand, are areas within Disciplines, and may be identified based on factors such as the content, count, and citations of millions of indexed publications. Unlike Disciplines, a Specialty can be shared among multiple Disciplines. Specialties and sub-Specialties are typically categorized together under a broader Specialty. For example, in particular embodiments cancer, cancer screening, and cancer prevention would be designated separately as Specialties. Similarly, in particular embodiments pollution, air pollution, and pollution prevention would also be categorized separately as Specialties. These designations for Field, Discipline, and Specialty are assigned based on a combination of factors, such as the publication, type of publication, and its associated technical programs and the scholar's publication history.

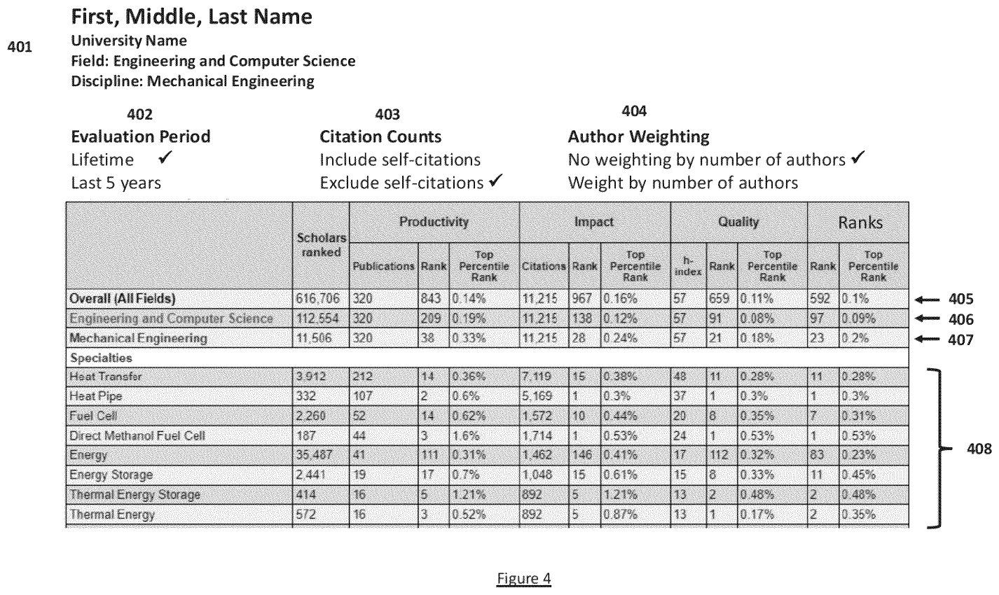

FIG. 4 illustrates example rankings specific to an individual. The example of FIG. 4 includes identifying information 401, such as the individual's name, affiliation, Field, and Discipline; the evaluation period 402 selected by the user; the treatment of self-citations 403 selected by the user; the treatment of author weighting 404 selected by the user; and Productivity, Impact, Quality and Ranks metrics overall (all Fields) 405, in the individual's Field (e.g. Engineering and Computer Science) 406, in the Individual's Discipline (e.g. Mechanical Engineering) 407, and in the individual's multiple Specialties (e.g. Heat Transfer, Heat Pipe, Fuel Cell, etc.) 408. Notably, as illustrated in FIG. 4 and as described more fully herein, the ranking process illustrated in FIG. 4 ranks the example individual in a single Field and Discipline but also in multiple Specialties, and the scholars ranked in each specialty are not confined to the same Field and Discipline as the individual in FIG. 4. As a result, relative expertise and performance in a particular Specialty can be determined among individuals across a number of Fields and Disciplines. For instance, with reference to the example of FIG. 4, it is clear that the individual is a particular expert in heat pipe, thermal energy, and related Specialties, while another individual in the same Discipline of Mechanical Engineering may be a relative in expert in entirely different specialties, such as structural integrity for bridges, skyscrapers, etc.

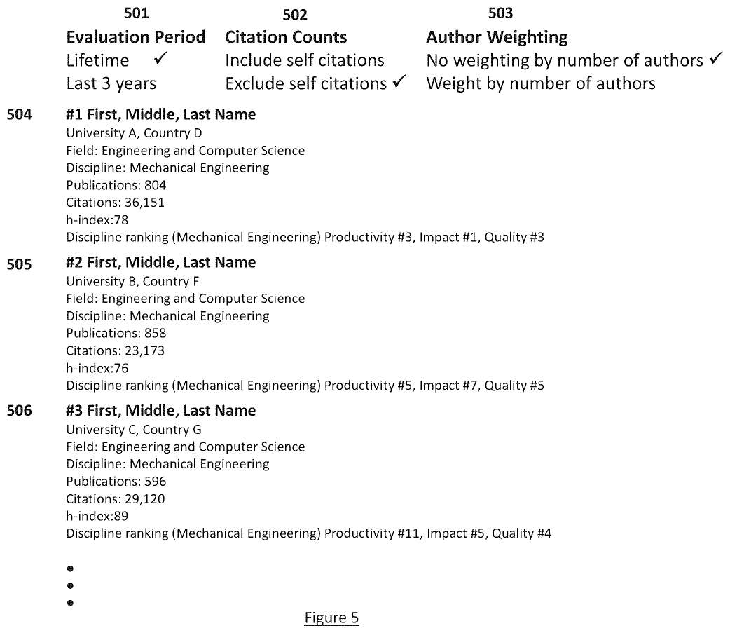

Particular embodiments provide an interactive user interface (UI) that allows a user to view rankings and adjust information such as ranking criteria, etc. FIG. 5 illustrates an example list of individual ranking in a Discipline (e.g. Mechanical Engineering) that may be presented on a UI, along with information such as the evaluation period 501 selected by the user, the treatment of self-citations 502, the treatment of author weighting 503, the name, affiliation, country, Field, Discipline, publication, citation, h-index as well as productivity, impact, and quality rankings of first ranked individual 504, second ranked individual 505, third ranked individual 506, and so on for the highest ranked top scholars in the Discipline. Similar lists can be generated and presented with top scholars (for example, those scholars referred to in this disclosure as Highly Ranked Scholars or Top Experts) overall (all Fields), top scholars in a Field, and top scholars in a Specialty. Similar lists can be generated and presented for top institutions overall (all Fields), top institutions in a Field, top institutions in a Discipline, and top institutions in a Specialty.

The system and methods described allow users to identify Highly Ranked Scholars within a Field, Discipline or in any Specialty. A Highly Ranked Scholar is a scholar whose composite ranking score (“Ranks,” below) places them in the top 0.xx % of all such scholars relative to the category (Field, Discipline or Specialty) they are being considered in. In particular embodiments, the lists of Highly Ranked Scholars are sortable by geographical region, affiliation, or other suitable criteria.

The systems and methods described herein allow users to rank Top Experts in niche Specialties based on the selected ranking metrics. A Top Expert is a scholar whose composite ranking score (“Ranks,” below) places them in the top 5% of all scholars. In particular embodiments, the lists of Top Experts are sortable by geographical region, affiliation, or other suitable criteria.

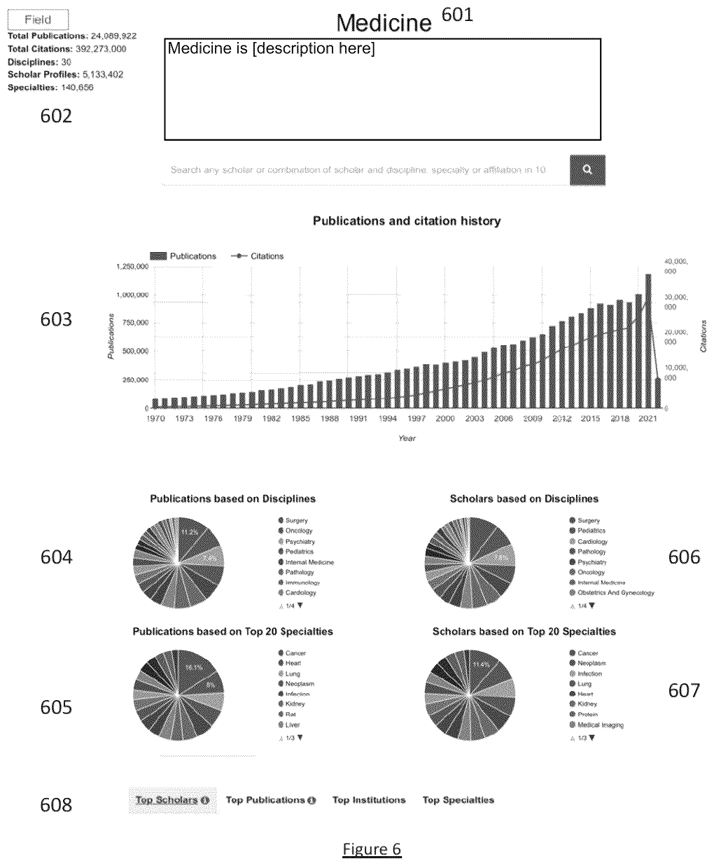

The systems and methods described herein may generate information pertaining to a selected Field or Discipline of interest. For instance, FIG. 6 illustrates an example of a UI in which a user has requested information specifically about the Field of Medicine. The example of FIG. 6 includes a description 601 (shown as an abstracted description; the actual description may be of any suitable type) of the Field; a summary 602 of the total publications, total citations, total scholar profiles, total number of Disciplines in the Field, and number of Specialties associated with the Field; publication and citation histories associated with the Field 603; a breakdown 604 of the total publications in the Field by Discipline; a breakdown 605 of the publications in the Field by top (most frequent) N Specialties, where N=20 in this example; a breakdown 606 of the number of scholars in the Field by Discipline; and breakdown 607 of the number of scholars in the top N Specialties, where N=20 in this example. Users may generate lists 608 of top ranked scholars, top (most highly cited) publications, top institutions, and top Specialties in the Field.

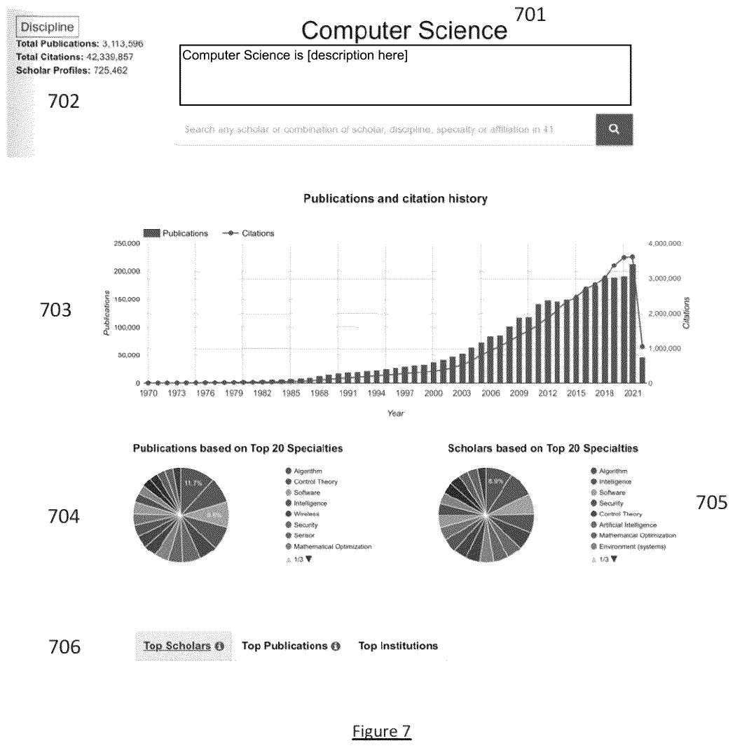

FIG. 7 illustrates an example of a UI in which a user has requested information specifically about the Discipline of Computer Science. The example of FIG. 7 includes a description of the Discipline 701; a summary 702 of the total publications, total citations, and total scholar profiles associated with the Discipline; publication and citation histories 703 associated with the Discipline; a breakdown 704 of the total publications in the Discipline by top N Specialties where N=20 in this example; and a breakdown 705 of the number of scholars in the top N Specialties where N=20 in this example. Users may generate lists 706 of top ranked scholars, top (most highly cited) publications, and top institutions, in the Discipline.

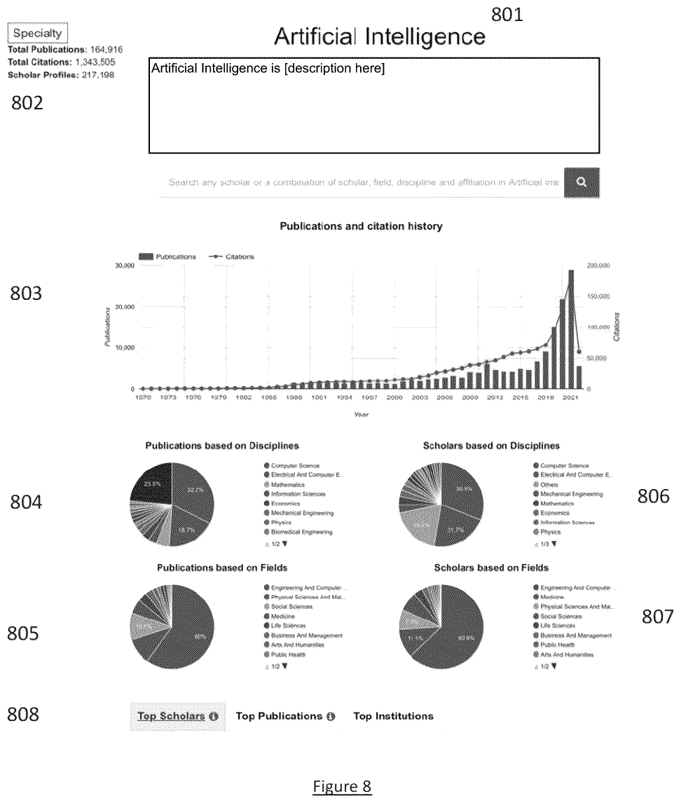

FIG. 8 illustrates an example of a UI in which a user has requested information specifically about the Specialty of Artificial Intelligence. The example of FIG. 8 includes a description 801 of the Specialty; a summary 802 of the total publications, total citations, and total scholar profiles, associated with the Specialty; publication and citation histories 803 associated with the Specialty; a breakdown 804 of the total publications in the Specialty by Discipline; a breakdown 805 of the total publications by Field; a breakdown 806 of the scholars in the Specialty by their Discipline; and a breakdown 807 of the number of scholars in the Specialty by their Field. Users may generate lists 808 of top ranked scholars, top (most highly cited) publications, and top institutions, in the Specialty.

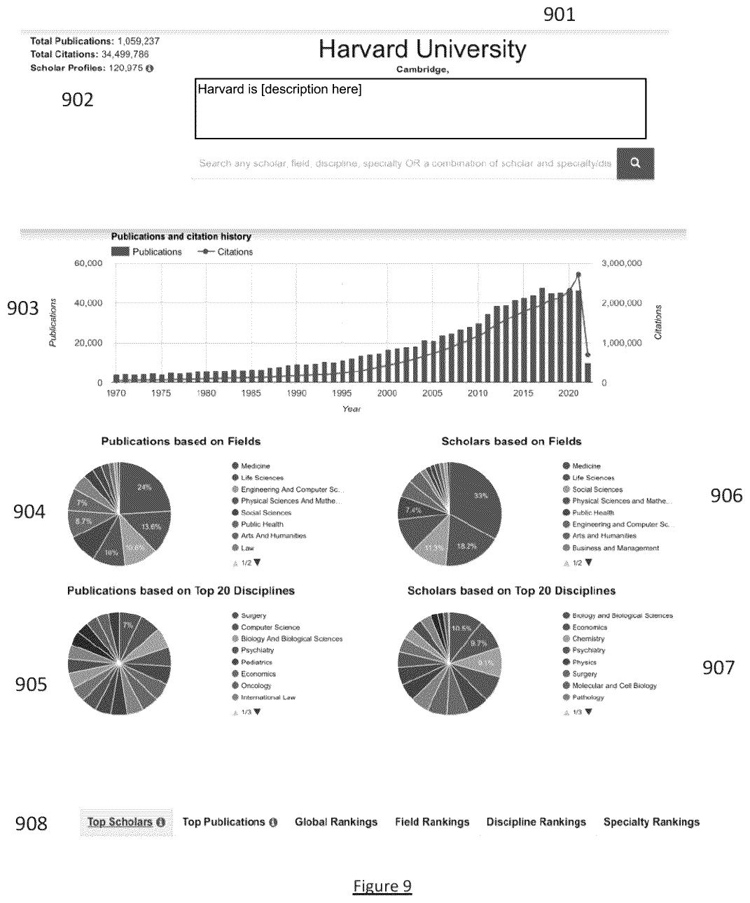

FIG. 9 illustrates an example of a UI in which a user has requested information specifically about the institution Harvard University. The example of FIG. 9 includes a description 901 of the institution; a summary 902 of the total publications, total citations, and total scholar profiles, associated with the institution; publication and citation histories 903 associated with the institution; a breakdown 904 of the total publications from the institution by Field, a breakdown 905 of the total publications from the institution by Discipline; a breakdown 906 of the scholars from the institution by their Field; and a breakdown 907 of the number of scholars from the institution in the top N Specialties, where N=20 in this example. Users may generate lists 908 of top ranked scholars, top (most highly cited) publications, global rankings of the institution, rankings of the Fields within the institution, rankings of the Disciplines within the institution, and rankings of the Specialties within the institution.

Embodiments of the systems and methods described herein may be used to develop detailed quantitative assessment and benchmarking reports, for example with each report customized for administrators and specific to their own academic or non-academic institution. The reports might include but not be limited to: 1) the user's institution ranking relative to all institutions worldwide based on Productivity, Impact, Quality, and Ranks (a metric described more fully below) comparisons, 2) institution-wide publication and citation histories of the user's institution, 3) detailed performance metrics (Productivity, Impact, Quality, Ranks) of each and every Field within the user's institution, 4) detailed performance metrics (Productivity, Impact, Quality, Ranks) of each and every Discipline within the user's institution, 5) detailed profiles of all scholars within the user's institution, 6) Field-level scholar size (number of scholars) and productivity (publications) comparison with all institutions worldwide and with institutions in the user's home country and with peer institutions identified by the user, 7) Field-level scholar size (number of scholars) and impact (citations) comparison with all institutions worldwide and with institutions in the user's home country and with peer institutions identified by the user, 8) Field-level scholar size (number of scholars) and quality (h-index) comparison with all institutions worldwide and with institutions in the user's home country and with peer institutions identified by the user, 9) Discipline-level scholar size (number of scholars) and productivity (publications) comparison with all institutions worldwide and with institutions in the user's home country and with peer institutions identified by the user, 10) Discipline-level scholar size (number of scholars) and impact (citations) comparison with all institutions worldwide and with institutions in the user's home country and with peer institutions identified by the user, 11) Discipline-level scholar size (number of scholars) and quality (h-index) comparison with all institutions worldwide and with institutions in the user's home country and with peer institutions identified by the user, 12) relative performance (high to low) of each and every Field within the user's institution based on each Field's ranking relative to the identical Field among institutions worldwide, 13) relative performance (high to low) of each and every Discipline within the user's institution based on each Discipline's ranking relative to the identical Discipline among institutions worldwide, 14) top scholars within the user's institution based on their lifetime performance overall (all Fields), 15) top scholars within the user's institution based on lifetime performance in the scholar's Field, 16) top scholars within the user's institution based on lifetime performance in the scholar's Discipline, 17) top scholars within the user's institution based on lifetime performance in the scholar's Specialty, 18) top scholars within the user's institution based on previous N years performance overall (all Fields) (e.g., N five), 19) top scholars within the user's institution based on previous N years performance in the scholar's Field where Nis a small number, say five, 20) top scholars within the user's institution based on previous N years performance in the scholars' Discipline where Nis a small number, say five, 21) top scholars within the user's institution base on previous N years performance in the scholar's Specialty where N is a small number, say five, 22) most highly-cited scholars within the user's institution based on lifetime performance overall (all Fields), 23) most highly-cited scholars within the user's institution based on lifetime performance in the scholar's Field, 24) most highly-cited scholars within the user's institution based on lifetime performance in the scholars' Discipline, 25) most highly-cited scholars within the user's institution based on lifetime performance in the scholar's Specialty, 26) most highly-cited scholars within the user's institution based on previous N years performance overall (all Fields) where N is a small number, say five, 27) most highly-cited scholars within the user's institution based on previous N years performance in the scholar's Field where N is a small number, say five, 28) most highly-cited scholars within the user's institution based on previous N years performance in the scholars' Discipline where N is a small number, say five, 29) most highly-cited scholars within the user's institution based on previous N years performance in the scholar's Specialty where N is a small number, say five, 30) most highly-cited publications (lifetime) emanating from the user's institution overall (all Fields), 31) most highly-cited publications (lifetime) emanating from the user's institution in each and every Field within the institution, 32) most highly-cited publications (lifetime) emanating from the user's institution in each and every Discipline within the institution, 33) most highly-cited publications (lifetime) emanating from the user's institution in Specialties within the institution, 34) most highly-cited publications (from previous N years where Nis a small number, say, five) emanating from the user's institution overall (all Fields), 35) most highly-cited publications (from previous N years where N is a small number, say, five) emanating from the user's institution in each and every Field within the institution, 36) most highly-cited publications (from previous N years where Nis a small number, say, five) emanating from the user's institution in each and every Discipline within the institution, 37) most highly-cited publications (from previous N years) emanating from the user's institution in Specialties within the institution.

In particular embodiments, a user may be required to login to a system for accessing entity profiles and generating rankings. For example, embodiments may employ a user authentication scheme which requires users to create a login profile in order to access the database and related functionality. In creating this login profile, users may choose to specifically associate the login profile with one and only one of the individual profiles created by the computer-based system and computational processes described herein and may be subject to the signing of Terms and Conditions attached to the use of the computer-based system and computational processes which requires, among other legal aspects, that the person associating the login profile with the individual profile generated by and stored by the system and methods described herein has asserted that they are the person identified by the individual profile generated by and stored by the systems and methods described herein.

In particular embodiments, a user who has created a login profile which they subsequently associate with an individual profile may amend the manner in which the associated individual profile is viewed by that user and by any other user who may view the profile. Such amendments include, but are not limited to, the addition of or deletion of publications, patents, prizes or any other pertinent information stored by the profile which the user deems to be omitted or in error. In particular embodiments, such amendments do not directly affect the stored individual profile database described herein, but are instead maintained in a separate database, for example as illustrated in FIG. 11. After a data record in this subsidiary database is updated or created, the rankings associated with the amended profile may be recomputed using the updated information. In particular embodiments, these recomputed rankings may be stored separately from the standard rankings and may be specifically notated to have been triggered by a user-initiated amendment to an individual profile.

If a user amendment to an individual profile is subsequently validated, for example according to the preprocessing steps described in connection with the example of FIG. 3, the amended data record stored in the subsidiary amendment database may be marked as “validated” and the record is then transferred to the primary profile database. Rankings previously annotated with the notation that they have been triggered by a user amendment may be reverted to standard rankings after an updated is validated.

FIG. 10 illustrates example profile database entries in which the relevant entities are individuals. In the example of FIG. 10, the individual profile database includes a number of linked data records indexed by a number of keys which captures the lifetime research profile of the individual. Entries in the database include (but are not limited to): the full name of the individual (1001), and any aliases (alternate spellings) (1002); the full current affiliation of the individual, including (for example) institution or institutions with which the individual is associated, department or departments with which the individual is associated, center or centers with which the individual is associated, the location or locations of the institutions with which the individual is associated, and the rank or position(s) held by the individual (1003); all prior affiliation(s) of the individual if such are known, together with dates of affiliation(s) (1004); the Field or Fields and Discipline or Disciplines within which the individual conducts research (1005); the Specialties associated with the individual, for example as determined from an analysis of the individual's publication history (1006); honors and awards or prizes awarded to the individual whether singly or jointly with others (1007); all publications (1008) authored by the individual either as sole author or jointly with others, including all publications recognized as patents, including titles and dates, obtained by the individual whether singly or jointly with others; all patents (1009), books or monographs (1010) or journal or conference papers (1011), such records to contain all relevant bibliographic information pertaining to the publication, including but not limited to title of the work, names and affiliations of all authors, venue in which the work appears including if appropriate volume and part numbers, full names and affiliations of editors of the publication if the publication was contained in an edited proceedings, full dates of publication, and full pagination; all citation counts to the individual's published works on a per-publication basis (1012); all grants and contracts awarded to the individual whether awarded singly or jointly with others, including source of grant or contract, amount of grant or contract, and dates of grant or contract (1013); and a record of the individual's co-authors including their affiliations and their Fields, Disciplines and Specialties (1014). As explained herein, the data for these entries may be determined during automatic and periodic data acquisition from a variety of sources, for example as illustrated in the example process of FIG. 3.

In particular embodiments, a database contains entries including but not limited to each individual's name and all aliases recognized as pertaining to the individual; the individual's current affiliation specified in terms of institution or institutions and subdivision or subdivisions of institutions; the individuals rank or position within each institution or institutions; the individual's past affiliations with institutions and years of service with those institutions; a complete list of the individual's publications, including but not limited to all patents, books, book chapters, monographs, journal and conference publications; for each such publication excluding patents, a complete list of the publication's title, keywords, publication venue including all relevant publisher information, dates of publication and pagination of publication; for each publication a complete list of the co-authors of the publication and their affiliations; for each patent all patent identification information, title, co-awardees and their affiliations, and date of issuance, for each publication, an assignment of the publication to a Field, a Discipline and all Specialties covered by the publication; a complete list of all grants and contracts awarded to the individual, including title, awarding body, amounts, dates and co-awardees, including affiliations, and all keywords associated with the grant or contract; a complete list of the number of citations made to each and every publication in the publication list made by authors including the individual identified by the Profile, but such self-citations specifically identified and distinguished from citations made to the individuals publications by individuals other than the individual associated with the profile; a complete list of all prizes and honors awarded to the individual, together with a list of all co-awardees of such prizes or honors; a complete list of all co-authors and collaborators of the individual as deduced from the co-authors of the individual's publications and patents, and the co-awardees of the individual's grants; a set of entries used to specify the Field, Discipline and Specialties associated with the individual; a non-specific data field to contain items of interest regarding the individual (such as but not limited to information concerning news stories regarding the individual's research activities); and a series of entries containing periodically updated statistically standardized ranking information regarding the individual, such as but not limited to the individual's h-index; degree of national or international collaboration; percentile standing relative to others in the individual's Field, Discipline or Specialty; or success in obtaining grants and contracts.

FIG. 11 illustrates an example architecture for the systems and methods disclosed herein. A variety of external digital data sources (1101) are automatically and periodically scanned by specific computer programs which implement specific data analysis methods. At 1102, the acquired digital records are converted to a uniform standard record type which reconciles synonyms and starts the author name disambiguation process. These data records are stored in an update storage system 1103 which maintains copies of the acquired data. Records in the update storage system 1103 are transferred to the primary individual profile database 1104 subject to an approval process called the Update Authority. The Update Authority approves or disapproves most updates automatically, but may refer particularly complex records which are not able to be validated automatically to system administrators for human intervention. For example, the update authority may access a database of known synonyms to automatically approve or disprove an update. Entries in the database of known synonyms may be predetermined and/or may be based on associations between words (and, in particular embodiments, their lexicographical role in the context of the data) in external data accessed, e.g., in step 301 of the example method of FIG. 3.

As stated previously, fundamental and derived metrics and rankings are determined periodically over the individual profile database. A Model-View-Controller architecture is implemented by a backend manager 1105, which contains a full model of the data and defines the logic and actions of the methods for which the database is used. Controller 1107 is the component of the computer-based system and computational processes which interacts with the Model to accomplish user requests. The controller is mediated by a User Database 1106 that includes user login credentials and associated access controls which defines actions a user accessing, or requesting access to, the system is permitted to take. Also associated with the User Database is an Amendment Database, which contains any amendments properly qualified users have made to the way in which the Individual Profile Database is subsequently analyzed and queried. In the example of FIG. 11, user queries are handled by the Data Partition and Analytic Filters 1108 which are able to provide ranking information based on static (pre-determined) partitions of the data (such as “top ranked University”, “top 100 individuals in specialty=Heat Pipes”), or, where appropriate given the user's access status, dynamically computed rankings (such as “top 20 individuals in Heat Pipes and Processor Cooling”, “ranking of Departments of Mechanical Engineering AND having fewer than 30 scholars OR having at least two scholars whose Specialty is in Mechatronics AND is located in the states of Washington OR Oregon OR California”). The Query and View Manager 1109 handles the interface between the users and the computer-based system and computational processes and is responsible for the UI viewed by each user dependent on the mode (e.g., text-only) or device (e.g., desktop, laptop, or mobile device) used by the user.

As described herein, particular embodiments of this disclosure disambiguate entity (e.g., individual researcher) names for determining the uniqueness of an entity. For example, multiple authors may share the name James Smith, multiple institutions may share the name Northeastern University, and multiple specialties may share the description “management” such as “risk management” in Business, “pain management” in Medicine, and “data management” in Computer Science. FIG. 12 illustrates an example disambiguation process. Information from a variety of sources is accessed by the system and in step 1201, an identity uniqueness index z is assigned to each string of information (including but not necessarily limited to author name, institution name, and specialty name). At step 1202, if r=1 and the string is valid (e.g. the institution associated with the string is known to exist either directly, or validated by employing artificial intelligence to cases where the institution name is simply misspelled), then at step 1203 the string is validated and the information associated with the string is sent to the profile database manager 1207 where it is prepared for inclusion in the profile database 1208. However, if at step 1202 τ>1, then at step 1204 the string undergoes disambiguation by employing artificial intelligence 1205 after which it is sent in step 1209) to a reject database manager 1210. where it is either (i) rejected at step 1211 (e.g. for cases where information in the string is shown to be invalid) or (ii) it is returned at step 1212 for further artificial intelligence disambiguation. The disambiguation process continues until the names of all authors, all institutions, and all Specialties are completely disambiguated in step 1206, after which the information associated with the string is sent to the profile database manager 1207 for use in the profile database 1208.

In particular embodiments, disambiguation may be based on different classifications for data. For example, a name (an individual name, or an institution name) may be classified into three categories: a unique name, a semi-popular name, and a popular name. Here, “unique” need not be, but may be, exclusive, in that, for example, a “unique” last name may be an uncommon last name (e.g., only 20 last names or only ˜5,000 total publications with an author having that last name, as determined, for example, from author data from publications). The semi-popular and popular categories may likewise each be associated with particular corresponding thresholds. In particular embodiments, r=1 if some data is unique, even if that data (e.g., a name) is not found in only a single instance in the profile database.

In particular embodiments, r and/or an associated classification for data uniqueness may be based on metadata associated with the data, such as publications, patents, grants or contract, and honors or prizes relative to the Field or Fields, Discipline or Disciplines, Specialty or Specialties associated with each publication, patent, grant or contract, or honor or prize, together with such information as co-authors or co-awardees. For example, a J. Wilson may be determined to be a unique name based on associated information that identifies the J. Wilson as publishing with the same authors and in the same specialties as a John Wilson.

In particular embodiments, the level of confidence required to determine that some data is disambiguated may vary based on the value of r. For example, if z is relatively high (e.g., associated with a determination that the data is not unique and may be associated with the “popular” label), then a higher confidence may be required for a classification from block 1305 to determine that the data is disambiguated. In particular embodiments, steps 1312 include an iterative or layered approach to the input data. For example, if a last name associated with a particular specialty does not result in disambiguation, then additional data (e.g., the names of co-authors) may be introduced in the next disambiguation attempt. If the result is still not disambiguated, then additional data may be used to disambiguate the result, different weightings may be used for the data, or the data may be surfaced for expert review.

As discussed above, particular embodiments of the systems and method disclosed herein distinguish between scholars with similar or disambiguated names, creating distinct profiles for each individual. For example, this process may include dividing names into three main groups: popular, semi-popular, and unique names. The approach used for each division varies and includes multiple steps, with more restricted matching requirements for popular names compared to semi-popular names, and similarly, more restricted requirements for semi-popular names compared to unique names. These three specific divisions are arbitrary and can be tailored to the specific application and requirements. The matching requirements and grouping order for a disambiguation process may be based on factors such as affiliation, co-authorship, field, discipline, specialty, publication type, and time history, among others. The degree of confidence and the priority of each matching requirement for associating a publication with a profile depend on the type of classification, i.e., on the group (e.g., semi-popular) within which the scholar appears. Additionally, particular embodiments of the systems and methods disclosed herein provide post-processing techniques for merging profiles with special matching requirements, which are different than the initial matching process.

Ranking of entities is determined by the computation of a variety of ranking metrics, some of which apply to individuals and some of which apply to institutions or sub-divisions thereof. This disclosure refers to institutions and sub-divisions as Units.

A Unit is defined by metadata entries in the computer-based system. While conventional entries include Units such as University, College, School, Department and Center, the systems and methods of this disclosure are flexible enough to allow for the arbitrary designation of any partitioning of the Individual Profile Database as a Unit; for example, ranking of groups of institutions by state or by country to permit state-by-state or country-by-country ranking comparisons.

Particular embodiments may utilize the ranking approach described below to rank individuals (scholars) and institutions of higher education. In this example, rankings for both scholars and institutions are evaluated in four ranking categories: (1) Overall (with respect to all Fields), (2) by Field, (3) by Discipline, and (4) by all Specialties with which they are associated. Four ranking metrics are calculated across each of the preceding four categories: (1) Productivity (archival publication count), (2) Impact (citation count), (3) Quality (h-index), and (4) “Ranks” (a weighted sum, such as the geometric mean, of Productivity, Impact, and Quality scores). Additionally, three ranking options are available for each ranking metric: (1) Duration (lifetime publications, or publications over a period of time, e.g., from the last five years), (2) Author contribution credit (no weighting based on the number of authors, or weighting authors' publication and citation counts based on the number of authors on a publication). For example, in this example ranking scheme if two authors are listed on a publication, each scholar will be credited with 0.5 publications and half of the publication's citations. The scholar's fractional h-index is also calculated based on these weighted citation counts. The ranking options are available for each ranking include (3) Citation inclusion (i.e., whether to include all citations or exclude self-citations [citations from publication by the same author]). Ranking metrics are calculated both in terms of standard competition rank (e.g., “1, 2, 3, 4, 5, 6, . . . ”) and top percentile (the complement of the percentile rank, e.g., “Top 3%”).

Continuing this example, scholars are ranked in each category and by each ranking metric for various criteria. The percentile rank of a scholar within a category for any ranking metric is calculated as follows:
N=Total scholars within a category
R=Standard competition rank of the scholar within a category
F=Frequency of scholars with rank R

$$Top Percentage Rank ( T P R ) = \frac{( N - R + 1 ) - ( 0.5 \times F )}{N} \times 100$$

where

Productivity TPR=TPRₚ=Top percentage rank by publication

Productivity TPR=TPR_{c}=Top percentage rank by citation count

Productivity TPR=TPRₕ=Top percentage rank by h−index

In particular embodiment, TPR is a decimal number.

The “Ranks” of an individual scholar is given by a pair of rankings [R,P] determined as follows. First, an intermediate score S is computed for each scholar. In particular embodiments, S may be determined by:

$$S = \frac{T P {R}_{p} + T P {R}_{c} + T P {R}_{h}}{3}$$

In particular embodiments, S may be determined by:

$$S = \sqrt[3]{{TPR}_{p} \times {TPR}_{c} \times {TPR}_{h}}$$

From the distribution of these intermediate scores the “Rank” can be determined as a pair of scores:

$$Ranks = [ SR , STPR ]$$

where
SR=Standard competition rank (S)
STPR=Top Percentage Range (SR)

Both the competition rank S and the complementary percentile rank SR for a scholar are determined by the value of that scholar's S score relative to the distribution of the values of all S scores from scholars in the population to which the scholar is being compared. For example, a Ranks pair can be determined for a given scholar relative to the universe of scholars (“Overall”), relative to those scholars in the scholar's Field or Discipline, or relative to those scholars active in any Specialty associated with the given scholar. Top scholars may be determined based on their Ranks with publications and citations weighted or not weighted by the number of authors, and including or not excluding self-citations on either lifetime or last five-year bases (see FIG. 5).

In particular embodiments, each ranking metric can be determined relative to a Field, a Discipline, or a Specialty; can be computed with or without author and citation weighting; and can be over the scholar's lifetime or the prior five-year period. Each ranking metric M is a multi-indexed entity M_{F,T}^{αβγ} where α is the duration over which the metric is determined (lifetime, prior five years, etc.), β indicates the weighting type (weighted/unweighted authors/citations), γ indicates whether self-citations are or are not included, F indicates the category over which the metric has been determined (Overall, Field, Discipline, or Specialty) and T indicates the metric type (Productivity, Impact, Quality, or composite score “Ranks”). To avoid this cumbersome notation, and because it will be clear from the context what the complete specification of the metric is, we drop all but the most necessary indices. For example, Mₚ would be a productivity-related metric, and the context will identify the other circumstances under which it was determined.

Categories of top scholars can be determined and identified based on their Ranks with publications and citations weighted by the number of authors and excluding self-citations. For example, top scholars reside in the top N % of ranked scholars (e.g., top 0.1%) in various Fields, Disciplines, and Specialties. Top experts can be determined on either a lifetime basis or based on a particular timeframe (e.g., the prior five years). As another example, highly ranked scholars may be defined as those with SR ranks of x % or better (e.g., ranks of 0.05% or better) relative to a specified group. The data used to identify a highly ranked scholar is based on lifetime activity, weighting each publication and citation by the number of authors, and excluding self-citations.

In particular embodiments, both Highly Ranked Scholars (HRS) and Top Experts (TE) are derived from a composite metric which involves Productivity, Quality and Impact. The assignment to one or other of the categories is based on a threshold which the metric must meet. For example, HRS may be scholars who achieve a rank of 0.05% or better given the ranking criteria.

Since the HRS and TE metrics are composite for the HRS & TE categories, the metrics do not limit the qualification into the categories to one specific type of excellence such as “highly cited researcher” as a result of excellence in Impact primarily (possible correlations with Productivity and Quality being understood). The composite metrics for these categories accommodate researchers who excel in other aspects of scholarly pursuit, provided their composite metric satisfies the constraints.

In particular embodiments, HRS and TE categories are determined over the Field/Discipline/Specialty hierarchy, and are specifically designed to be Field/Discipline/Specialty sensitive. For example, a scholar may be a HRS (i.e., the scholar's composite metric meets the HRS threshold) in a particular specialty in which they work, but not another specialty. Likewise, a scholar may be a HRS in a particular discipline, but not in the field that includes that discipline. As illustrated by these examples, a scholar's metrics may (and probably will) vary across Field/Discipline/Specialty categories and among different fields, disciplines, and specialties in which they work. In contrast, raw metrics such as “most highly cited” may not take into consideration Field/Discipline/Specialty statistics. Thus, the HRS/TE of this disclosure can identify a scholar of History as an HRS whereas the raw metrics taken independent of the discipline would be swamped by the metric scores of average scholars in (say) Medicine.

Since the HRS/TE categories as determined relative to the Field/Discipline/Specialty hierarchy, it is possible to track the “degree” of HRS/TE excellence relative to the specific subgraph of the Field/Discipline/Specialty hierarchy that the scholar's activities pertain to e.g., particular embodiments of this disclosure can track whether an HRS scholar in (say) Computational Quantum Chemistry is also an HRS in the level above (Quantum Mechanics) or the level above that (Physical Chemistry) or the level above that (Chemistry) or in the Field of Physical Sciences and Mathematics.

In particular embodiments, the HRS/TE categories can be determined with respect to geographical or temporal divisions. For example, particular embodiments may determine HRS/TE qualifications restricted to various geographical hierarchies (e.g., Malaysia->Malay Peninsula->Far Orient->Asia) and/or to a temporal hierarchy (e.g., [1980-2020]->[2000-2020]->[2010->2020]), etc.

Academic institutions may be ranked in each category for which a minimum threshold of active faculty members is met (see Ranking Factors). Institution rankings are based on publications associated with the institution over a particular time period (e.g., the prior five-year period) as well as the citations of those publications. In general, the ranking categories for an institution are representative of the following areas within an institution: (1) Overall (the institution overall); (2) Fields: Schools or Colleges (e.g., College of Engineering); (3) Disciplines: Departments (e.g. Department of Mechanical Engineering); and (4) Specialties (e.g. Institutes or Research Centers).

An institution's ranking may be calculated based on productivity (e.g., number of publications), impact (e.g., citations), and quality (e.g., h-index). In order to qualify for inclusion in an institution's ranking, a publication might be required to meet criteria such as but not limited to: (1) have an author who was associated with the institution when the publication was published and/or (2) have been published within the last five years. To ensure ranking fairness regardless of the size of the institution, the institution's publication and citation counts can be weighted by the number of active faculty members at the institution. Scholars might be considered “active faculty members” of an institution if they satisfy criteria such as but not limited to both of the following: (1) have at least one publication within the institution in the last five years and/or (2) have published (at any institution) at least seven years ago.

A critical mass of quality scholars necessary for institutional rankings may be used to (1) make institutional rankings nearly independent of institution size and (2) avoid penalizing institutions for scholars who are inactive, or active in only a small number of focused research areas.

Below is an example of an institution ranking determination. The percentage rank of an institution within a ranking category may be calculated, similar to the percentile rank of a scholar within a ranking category, as follows:
N=Total institutions within a category
R=Absolute competition rank of the institution within a category
F=Frequency of institutions with rank R

$$Institution Percentile Rank ( IPR ) = \frac{( N - R + 1 ) - ( 0.5 \times F )}{N} \times 100$$

The top percentile for institution rankings may be defined as:

$$Institution Top Percentile = 100 - IPR$$

Institutional rankings in specific Fields, Disciplines, and Specialties may proceed as follows. To calculate the institution rankings for Fields, Disciplines, and Specialties, a publication credit factor may first be assigned for each publication contributing to the ranking category. For any publication p and institution i, the publication credit factor PCFp,i may be defined as:

$${PCF}_{p , i} = \frac{Number of authors on publication p from institution i}{Total number of authors on publication p}$$

The per capita publication and citation counts for Fields, Disciplines, and Specialties within an institution may then calculated as follows:
Pᵢ=Set of publications in ranking category for institution i
AFᵢ=Number of active faculty members in ranking category for institution i
Cₚ=Number of citations for publication p
Per capita publication count (productivity) of institution

$$i = \frac{{\sum }_{p ∈ {P}_{i}} {PCF}_{p , i}}{{AF}_{i}}$$

Per capita citation count (impact) of institution

$$i = \frac{{\sum }_{p ∈ {P}_{i}} ( {PCF}_{p , i} \times {C}_{p} )}{{AF}_{i}}$$

Note that self-citations are included for institution rankings, in this example.

The per capita h-index (quality) of an institution for Fields, Disciplines, and Specialties is calculated the same way as the h-index of a scholar, and is based on the weighted citation counts of the institution (i.e., using fractional h-index).

The per capita publication count (productivity), per capita citation count (impact), and per capita h-index (quality) are calculated for all institutions within a ranking category, and then ranked to determine the Productivity, Impact, and Quality top percentiles of each category, as described in the Institution Top Percentile section above.

Institution rankings across all Fields (global) might proceed as follows. In order to account for a variety of differences in publishing patterns across academic Fields, the Impact, Productivity, and Quality of the entire institution is evaluated using Field-weighted scores. The Field-weighted Productivity, Impact, and h-index top percentiles are based both on (i) the ranking of the Fields that comprise the institution and (ii) the proportion of the institution's active faculty members in each Field. The calculation for an institution i might proceed as follows:
FIPR_{i,f,p}=Institution top percentile for institution i in Field f for productivity
FIPR_{i,f,c}=Institution top percentile for institution i in Field f for impact
FIPR_{i,f,h}=Institution top percentile for institution i in Field f for quality
Fᵢ=Set of Fields ranked for institution i
AFᵢ=Total number of active faculty members within institution i
AF_{i,f}=Total number of active faculty members within institution i for Field f
Weighted publication top percentile (productivity) of institution

$$i = {\sum }_{f ∈ {F}_{i}} ( {FIPR}_{i , f , p} \times \frac{{AF}_{i , f}}{{AF}_{i}} )$$

Weighted publication top percentile (impact) of institution

$$i = {\sum }_{f ∈ {F}_{i}} ( {FIPR}_{i , f , c} \times \frac{{AF}_{i , f}}{{AF}_{i}} )$$

Weighted publication top percentile (quality) of institution

$$i = {\sum }_{f ∈ {F}_{i}} ( {FIPR}_{i , f , h} \times \frac{{AF}_{i , f}}{{AF}_{i}} )$$

The weighted publication top percentile (productivity), weighted citation top percentile (impact), and weighted h-index top percentile (quality) are calculated for all institutions, and then all institutions are ranked to determine the Productivity, Impact, and Quality top percentiles of each institution, as described in the Institution Top Percentile section above.

Below is another example of ranking institutions based on specialties, disciplines, and fields. Since Specialties are characterized by focused scholarly activities that may span across multiple Disciplines, and because publication and citation traditions can vary substantially from Discipline-to-Discipline and Specialty-to-Specialty, care must be taken in the ranking of institutions relative to this ranking category. However, regardless of the Specialty, the Institution's ranking in any Specialty must reflect both the quality and quantity of outstanding scholars associated with the Specialty. The institutional Specialty Rank Score may be defined as:

$${l}_{s} = {\sum }_{a ∈ A} ( 100 - {STPR}_{a} )$$

where:
lₛ is the Institutional Rank Score in Specialty s;
A is the set of admissible scholars in the institution relative to Specialty s; and
STPRₐ is the Top Percentage Rank of Scholar a.

As for Specialties, Disciplines are characterized by focused scholarly activities, and because publication and citation traditions can vary substantially from Discipline-to-Discipline, care must be taken in the ranking of institutions relative to Disciplines. The institutional Discipline Rank Score may be defined as:

$${l}_{d} = {\sum }_{a ∈ A} ( 100 - {STPR}_{a} )$$

where:
l_{d} is the Institutional Rank Score in Discipline d;
A is the set of admissible scholars in the institution relative to Discipline d; and
STPRₐ is the Top Percentage Rank of Scholar a.

As noted above, each Discipline is associated with one and only one Field. Therefore, institutional excellence in the Disciplines that comprise a Field will yield a high institutional ranking in the Field. The institutional Field Rank Score may be defined as:

$${l}_{f} = {\sum }_{a ∈ A} ( 100 - {STPR}_{a} )$$

where:
l_{f} is the Institutional Rank Score in Field f;
A is the set of admissible scholars associated with the institution relative to the Disciplines belonging to Field f; and
STPRₐ is the Top Percentage Rank of Scholar a.

The Institution Overall Score for a ranking category might be calculated as an average of the institution's productivity, impact, and quality percentile ranks in that ranking category.

Productivity IPR=IPRₚ=Institution percentile rank by per capita publication score

Impact IPR=IPR_{c}=Institution percentile rank by per capita citation score

Quality IPR=IPRₕ=Institution percentile rank by per h−index score

$$Institution Overall Score = \frac{{IPR}_{p} + {IPR}_{c} + {IPR}_{h}}{3}$$

Note that 0<Institution Overall Score <100.

As another example of Overall ranking score, the institutional Overall Rank Score may be defined as:

$${l}_{o} = {\sum }_{a ∈ A} ( 100 - {STPR}_{a} )$$

where
lₒ is the Overall Institutional Rank Score;
A is the set of admissible scholars associated with the institution across all Disciplines; and
STPRₐ is the Top Percentage Rank of Scholar a.

The Overall rank of an institution within a ranking category can be determined based on the Overall Scores for all institutions within the category. These Overall ranks are then used to determine the Overall Top Percentile for each institution in the category.

Ranking factors may be employed in any ranking scheme that utilizes the computer-based system and computational processes described in this disclosure. Publications with over M authors, where M is a large number (e.g., 30), can be excluded from scholarly profiles and/or individual or institution ranking schemes because in such cases it is often difficult to ascertain individual contributions to the publication. In order for an institution to be eligible for an institutional ranking, a minimum number of active scholars might be required for the given ranking category types such as but not limited to the examples given here: Field: 20+ active faculty members; Discipline: 10+ active faculty members and Specialty: 1+ active faculty members.

In particular embodiments, an institutional Assessment and benchmarking process provides an unbiased assessment of an institution's scholarship based on the productivity, quality, and impact of the institution's scholars on an Overall (over all Fields) basis, in each Fields, in each Discipline, and in each Specialty. Assessments and benchmarking can be on a lifetime timeframe (over all years) or on a more recent, shorter timeframe such as (but not limited to) the last three, four, five, 10, or 20 years.

In particular embodiments, an institutional Assessment and benchmarking process provides an unbiased comparison of (i) any institution's recent and/or lifetime rankings, scholar size, productivity, quality, and impact on an Overall (over all Fields) basis, for each Field and Discipline, and for any Specialty to (ii) the rankings, scholar size, productivity, quality, and impact of: all institutions worldwide, institutions in the same country, and/or peer institutions. Peer institutions can either be selected by a user, or determined automatically based on, for example, similarities in the number of scholars and the distribution of scholars among the Fields or Disciplines between multiple institutions.

In particular embodiments, an institutional Assessment and benchmarking process provides unbiased identification and rank ordering of an institution's highly ranked or other categories of exceptional scholars over all Fields as well as exceptional scholars in their Field, in their Discipline, and in their Specialties in terms of the scholar ranking, productivity, quality, and impact. This enables the unbiased comparison of two scholars who are in different Fields, Disciplines, or Specialties with vastly different traditions of publication and citation, such as computer science versus history.

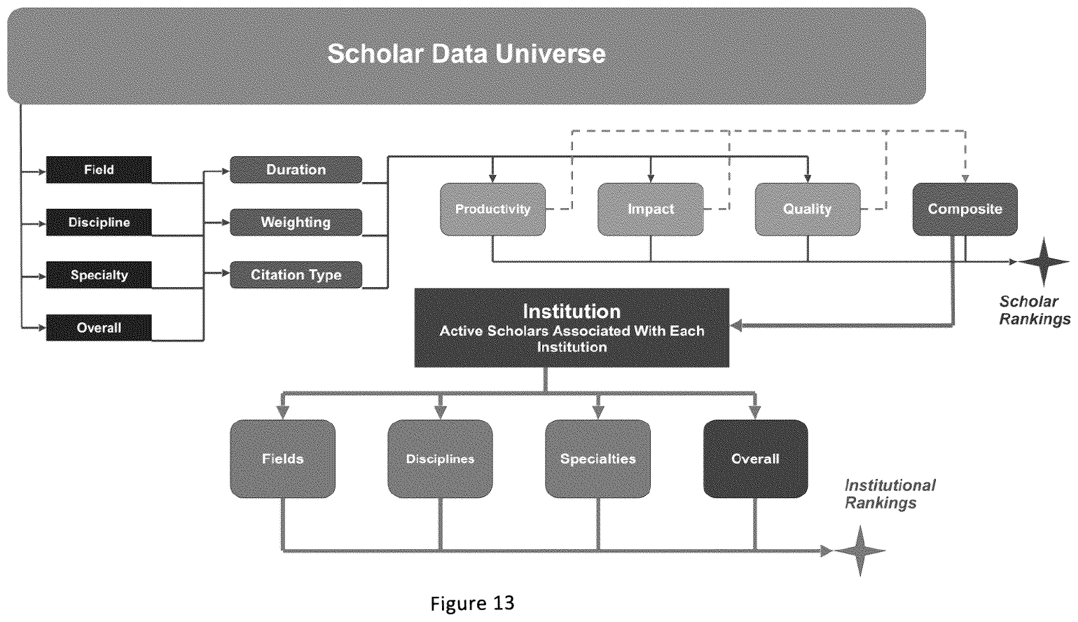

FIG. 13 illustrates a high-level schematic illustrating example data flows and procedural elements of an example ranking approach for ranking scholars and institutions in accordance with the description herein.

As described above, the systems and methods described herein provide for rankings of a multitude of scholars and institutions, taking into account the massive amount of work product generated by those entities. FIG. 14 illustrates an example of such numbers, including the amount of data used to rank scholars and institutions and the corresponding number of profiles resulting from the systems and methods described herein.

In particular embodiments, the systems and methods described herein may be used to generate a complete relationship structure (such as a relationship graph) for an entity. For example, a genealogy may be constructed based on database information to show the relationship of individual researchers to their academic advisers and mentors and to those peers who share academic advisers and mentors.

In particular embodiments, the systems and methods described herein may be used to generate a complete graph of individual collaborations, showing not only the immediate links between the individual specified and that individual's immediate collaborators, whether co-authors or co-awardees, but also the collaborators of the collaborators, with such a graph constructed to any diameter or depth (i.e., maximum number of proximate non-immediate collaborators) specified. In particular embodiments, a collaboration graph may be used to generate an inter-collaborator citation index for each individual in the Profile Database. Such an inter-collaborator citation metric will demonstrate the degree to which the citations of an individual's publications arise from direct collaborators such as co-authors. Such a metric may be used by academic administrators and others to identify self-citing rings of authors.

As explained above, raw ranking metrics may be stored in association with an entity profile. For example, for a profile corresponding to an individual researchers, raw ranking metrics may include that individuals' total number of journal papers, total number of conference papers, total number of books, total number of patents, total number of National Science Foundation (NSF) awards, total dollar amount of NSF grants, number of National Institutes of Health (NIH) awards, total dollar amount of NIH grants, total citations, number of citations per publication, h-index, a metric derived from national and international awards and honors, and total number of publications among the top highly cited by field, discipline, and specialty. Each metric may include an identification and/or description of each item in the entry (e.g., of each journal paper). For ranking purposes, and for each metric, an equivalent statistically standardized metric is derived, such as a z-score or a percentile ranking. In particular embodiments, these raw metrics may be associated with the individual's particular fields, disciplines, and specialties corresponding to a data point (e.g., a paper regarding “heat pipes” may be associated with the “heat pipe” specialty).

A profile corresponding to an institution and major subdivision thereof (including departments and centers, ranking metrics may include that institution's/subdivision's total number of journal papers; mean, median, variance, skewness and kurtosis of journal papers per scholar; total conference papers; mean, median, variance, skewness and kurtosis of conference papers per scholar; total number of books; mean, median, variance, skewness and kurtosis of number of books per scholar; total patents; mean, median, variance, skewness and kurtosis of patents per scholar; total number of National Science Foundation (NSF) awards; mean, median, variance, skewness and kurtosis of number of NSF awards per scholar; total NSF funding (dollars); mean, median, variance, skewness and kurtosis of NSF funding per scholar; total number of National Institutes of Health (NIH) awards; mean, median, variance, skewness and kurtosis of number of NIH awards per scholar; total NIH funding (dollars); mean, median, variance, skewness and kurtosis of NIH funding per scholar; mean, median, variance, skewness and kurtosis of h-index per scholar; total number of national and international awards and prizes; total number of publications among the top highly cited; percentage of publications among the top highly cited; percentage of faculty in science, medicine and engineering having NSF funding; percentage of faculty in science, medicine and engineering having NIH funding; the degree of national collaboration of the institution in terms of a metric identifying the degree to which the faculty collaborate with faculty in other (national) institutions; and the degree of international collaboration of the institution in terms of a metric identifying the degree to which the faculty collaborate with faculty in other (international) institutions. Each metric may include an identification and/or description of each item in the entry for ranking purposes, and for each metric, an equivalent statistically standardized metric is derived, such as a z-score or a percentile ranking. In particular embodiments, these metrics may be based on institutional activity or by scholar activity (e.g., including data for scholars associated with the institution that may not be coincident with institutional divisions).

For ranking purposes, ranking may be based on any desired metric or weighted combination of metrics.

Particular embodiments may generate a time-series of metrics and rankings such that each metric or ranking variable is determined on an annual basis over some time period. A variety of standard time-series analytic tools such as but not limited to Moving Average (MA) and Autoregressive-Moving Average (ARMA) are applied to the time series derived above to demonstrate such aspects of the series as trends and identify possible near-term predictions for the progression of the ranking of the institution or subdivision thereof. For example, a time-series of the statistically standardized metrics associated with various Specialties may identify Specialties which are declining in popularity (for example, as evidenced by decreasing publication or citation counts) or are growing in popularity (for example, as evidenced by increasing publication or citation counts).

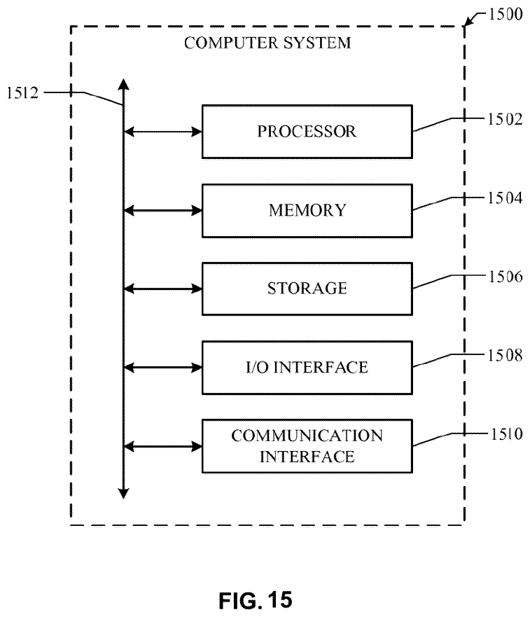

FIG. 15 illustrates an example computer system 1500. In particular embodiments, one or more computer systems 1500 perform one or more steps of one or more methods described or illustrated herein. In particular embodiments, one or more computer systems 1500 provide functionality described or illustrated herein. In particular embodiments, software running on one or more computer systems 1500 performs one or more steps of one or more methods described or illustrated herein or provides functionality described or illustrated herein. Particular embodiments include one or more portions of one or more computer systems 1500. Herein, reference to a computer system may encompass a computing device, and vice versa, where appropriate. Moreover, reference to a computer system may encompass one or more computer systems, where appropriate.

This disclosure contemplates any suitable number of computer systems 1500. This disclosure contemplates computer system 1500 taking any suitable physical form. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example and not by way of limitation, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

In particular embodiments, computer system 1500 includes a processor 1502, memory 1504, storage 1506, an input/output (I/O) interface 1508, a communication interface 1510, and a bus 1512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1502 includes hardware for executing instructions, such as those making up a computer program. As an example and not by way of limitation, to execute instructions, processor 1502 may retrieve (or fetch) the instructions from an internal register, an internal cache, memory 1504, or storage 1506; decode and execute them; and then write one or more results to an internal register, an internal cache, memory 1504, or storage 1506. In particular embodiments, processor 1502 may include one or more internal caches for data, instructions, or addresses. This disclosure contemplates processor 1502 including any suitable number of any suitable internal caches, where appropriate. As an example and not by way of limitation, processor 1502 may include one or more instruction caches, one or more data caches, and one or more translation lookaside buffers (TLBs). Instructions in the instruction caches may be copies of instructions in memory 1504 or storage 1506, and the instruction caches may speed up retrieval of those instructions by processor 1502. Data in the data caches may be copies of data in memory 1504 or storage 1506 for instructions executing at processor 1502 to operate on; the results of previous instructions executed at processor 1502 for access by subsequent instructions executing at processor 1502 or for writing to memory 1504 or storage 1506; or other suitable data. The data caches may speed up read or write operations by processor 1502. The TLBs may speed up virtual-address translation for processor 1502. In particular embodiments, processor 1502 may include one or more internal registers for data, instructions, or addresses. This disclosure contemplates processor 1502 including any suitable number of any suitable internal registers, where appropriate. Where appropriate, processor 1502 may include one or more arithmetic logic units (ALUs); be a multi-core processor; or include one or more processors 1502. Although this disclosure describes and illustrates a particular processor, this disclosure contemplates any suitable processor.

In particular embodiments, memory 1504 includes main memory for storing instructions for processor 1502 to execute or data for processor 1502 to operate on. As an example and not by way of limitation, computer system 1500 may load instructions from storage 1506 or another source (such as, for example, another computer system 1500) to memory 1504. Processor 1502 may then load the instructions from memory 1504 to an internal register or internal cache. To execute the instructions, processor 1502 may retrieve the instructions from the internal register or internal cache and decode them. During or after execution of the instructions, processor 1502 may write one or more results (which may be intermediate or final results) to the internal register or internal cache. Processor 1502 may then write one or more of those results to memory 1504. In particular embodiments, processor 1502 executes only instructions in one or more internal registers or internal caches or in memory 1504 (as opposed to storage 1506 or elsewhere) and operates only on data in one or more internal registers or internal caches or in memory 1504 (as opposed to storage 1506 or elsewhere). One or more memory buses (which may each include an address bus and a data bus) may couple processor 1502 to memory 1504. Bus 1512 may include one or more memory buses, as described below. In particular embodiments, one or more memory management units (MMUs) reside between processor 1502 and memory 1504 and facilitate accesses to memory 1504 requested by processor 1502. In particular embodiments, memory 1504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1504 may include one or more memories 1504, where appropriate. Although this disclosure describes and illustrates particular memory, this disclosure contemplates any suitable memory.

In particular embodiments, storage 1506 includes mass storage for data or instructions. As an example and not by way of limitation, storage 1506 may include a hard disk drive (HDD), a floppy disk drive, flash memory, an optical disc, a magneto-optical disc, magnetic tape, or a Universal Serial Bus (USB) drive or a combination of two or more of these. Storage 1506 may include removable or non-removable (or fixed) media, where appropriate. Storage 1506 may be internal or external to computer system 1500, where appropriate. In particular embodiments, storage 1506 is non-volatile, solid-state memory. In particular embodiments, storage 1506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1506 taking any suitable physical form. Storage 1506 may include one or more storage control units facilitating communication between processor 1502 and storage 1506, where appropriate. Where appropriate, storage 1506 may include one or more storages 1506. Although this disclosure describes and illustrates particular storage, this disclosure contemplates any suitable storage.

In particular embodiments, I/O interface 1508 includes hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1508 for them. Where appropriate, I/O interface 1508 may include one or more device or software drivers enabling processor 1502 to drive one or more of these I/O devices. I/O interface 1508 may include one or more I/O interfaces 1508, where appropriate. Although this disclosure describes and illustrates a particular I/O interface, this disclosure contemplates any suitable I/O interface.

In particular embodiments, communication interface 1510 includes hardware, software, or both providing one or more interfaces for communication (such as, for example, packet-based communication) between computer system 1500 and one or more other computer systems 1500 or one or more networks. As an example and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1510 for it. As an example and not by way of limitation, computer system 1500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1500 may include any suitable communication interface 1510 for any of these networks, where appropriate. Communication interface 1510 may include one or more communication interfaces 1510, where appropriate. Although this disclosure describes and illustrates a particular communication interface, this disclosure contemplates any suitable communication interface.

In particular embodiments, bus 1512 includes hardware, software, or both coupling components of computer system 1500 to each other. As an example and not by way of limitation, bus 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1512 may include one or more buses 1512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
receiving a request from a user for a ranking of a plurality of entities, the ranking based on a plurality of ranking metrics for each entity, each entity associated with a profile in a profile database, wherein an entity's associated profile contains information corresponding to each of the plurality of ranking metrics for that entity; and
providing, in response to the request, a user interface comprising a ranking of the plurality of entities.

2. The method of claim 1, wherein the plurality of entities comprise academic scholars, academic institutions, or one or more departments within an academic institution.

3. The method of claim 2, wherein the rankings are categorized by field, discipline, and specialty, wherein:
each field is associated with one set of disciplines;
each discipline is associated with only one field and with one or more specialties; and
each specialty is associated with one or more disciplines.

4. The method of claim 3, wherein the number of fields and the identity of each field is static, and the number of specialties and the identity of each specialty is dynamically determined.

5. The method of claim 4, wherein the ranking metrics comprise:
publications associated with an entity;
citations associated with an entity;
academic awards associated with an entity; and
an h-index score associated with an entity.

6. The method of claim 5, wherein the data for each ranking metric is associated with a particular field, discipline, and specialty.

7. The method of claim 1, further comprising:
determining, for each of a plurality of accessed data sources, an entity corresponding to the data source;
updating a profile corresponding to the entity in the profile database, based on information from at least one of the accessed data sources.

8. The method of claim 2, wherein providing the ranking comprises:
determining, for each of the plurality of entities, and based on the ranking metrics, that entity's production score, quality score, and impact score;
determining, for each entity, a total score that is based on each of the productivity score, quality score, and impact score for that entity; and
ranking each of the plurality of entities based on the total score.

9. The method of claim 8, further comprising determining whether to provide, along with the ranking, an identification of each scholar in the ranking as a highly ranked scholar or as a top expert based on that scholar's total score relative to all other scholars' total score in that ranking.

10. The method of claim 9, wherein the relative ranking of a scholar's total score varies based on whether the ranking is for a particular field, a particular discipline, or a particular specialty.

11. The method of claim 8, wherein the user interface comprises one or more interactive elements for displaying the ranking of the plurality of entities based on any of the productivity score, the quality score, the impact score, and the total score.

12. The method of claim 8, wherein the total score comprises a geometric mean or an arithmetic mean of the productivity score, the quality score, and the impact score.

13. The method of claim 8, wherein the rankings are categorized by field, discipline, and specialty, wherein:
each field is associated with a single set of disciplines; and
each discipline is associated with a single field and with one or more specialties; and
each specialty is associated with one or more disciplines; and
ranking each of the plurality of entities based on the total score comprises ranking each of the entities as grouped by field, discipline, or specialty, wherein the total score is based on ranking-metric data associated both with the entity and with the specific grouping used for ranking.

14. The method of claim 1, further comprising:
determining, based on accessed external data, information for updating the profile database; and
disambiguating an identification of an entity associated with the information to determine a profile to update with the information.

15. The method of claim 14, wherein disambiguating the identification of the entity associated with the information comprises:
classifying the identification of the entity into one of a plurality of classes, wherein each of the plurality of classes is based on how commonly an identification occurs; and
disambiguating the identification of the entity based on threshold associated with the particular class, wherein each class is associated with a different threshold.

16. The method of claim 14, wherein disambiguating the identification of the entity associated with the information comprises determining, based on a value z associated with the identification of the entity associated with the information, that the identification of the entity associated with the information is disambiguated.

17. The method of claim 14, wherein disambiguating the identification of the entity associated with the information comprises:
determining, based on a value r associated with the identification of the entity associated with the information, that the identification of the entity associated with the information is not disambiguated;
iteratively providing the identification of the entity associated with information and metadata from the accessed external data to a machine-learning architecture trained to disambiguate the type of information being disambiguated, wherein each iteration is based on determining, based on output from the trained machine-learning model from the previous iteration, that the identification of the entity associated with the information has not been disambiguated.

18. The method of claim 3, further comprising:
receiving a request from a user for information associated with a specific researcher, institution, field, discipline, or specialty; and
providing, in response the request from the user, a user interface comprising a description of the researcher, institution, field, discipline, or specialty and one or more metrics associated with that researcher, institution, field, discipline, or specialty.

19. The method of claim 18, wherein the request comprises a request for information associated with a specific researcher, and the user interface further comprises a ranking for the specific researcher in each specialty with which that researcher is associated along with an identification of the corresponding specialty.

20. The method of claim 2, wherein providing the ranking comprises:
determining, for each of the plurality of institutions, and based on the ranking metrics, a production score, quality score, and impact score for each scholar within that institution over a particular time period;
determining, for each institution, a total score over the particular time period that is based on each of that institution's scholar's productivity score, quality score, and impact score over that time period; and
ranking each of the plurality of institutions based on the total score over the time period.

21. One or more non-transitory computer readable storage media storing instructions and coupled to one or more processors that are operable to execute the instructions to:
receive a request from a user for a ranking of a plurality of entities, the ranking based on a plurality of ranking metrics for each entity, each entity associated with a profile in a profile database, wherein an entity's associated profile contains information corresponding to each of the plurality of ranking metrics for that entity; and
provide, in response to the request, a user interface comprising a ranking of the plurality of entities.

22. The media of claim 21, wherein the plurality of entities comprise academic scholars, academic institutions, or one or more departments within an academic institution.

23. A system comprising:
one or more non-transitory computer readable storage media storing instructions; and one or more processors coupled to the non-transitory computer readable storage media, the one or more processors operable to execute the instructions to:
receive a request from a user for a ranking of a plurality of entities, the ranking based on a plurality of ranking metrics for each entity, each entity associated with a profile in a profile database, wherein an entity's associated profile contains information corresponding to each of the plurality of ranking metrics for that entity; and
provide, in response to the request, a user interface comprising a ranking of the plurality of entities.

24. The system of claim 23, wherein the plurality of entities comprise academic scholars, academic institutions, or one or more departments within an academic institution.
